(19) United States
(12) Patent Application Publication
(10) Pub. No.: US 2012/0169900 A1
(43) Pub. Date: Jul. 5, 2012

(54) IMAGE PROCESSING DEVICE AND IMAGE PROCESSING METHOD

(75) Inventor: Satoshi NUMATA, Tokyo (JP)

(73) Assignee: Sony Corporation, Tokyo (JP)

(21) Appl. No.: 13/312,187

(22) Filed: Dec. 6, 2011

(30) Foreign Application Priority Data
Jan. 5, 2011 (JP) 2011-000803

(51) Int. Cl. H04N 5/76

(52) U.S. Cl. 348/231.99; 348/E07.085

(57) ABSTRACT

An image processing device includes an image processor that calculates a motion vector between image data of a target frame and image data of a reference frame in units of a block, and a reference frame image memory that retains image data of a past frame as the image data of the reference frame. Furthermore, the image processing device includes a primary memory that retains a matching processing range of the reference frame in calculation by the image processor, and a secondary memory that reads out and retains image data of a desired range from the image data of the reference frame stored in the reference frame image memory. The secondary memory reads out data of the matching processing range from the retained image data and supplies the read data to the primary memory.

### BACKGROUND

This disclosure relates to an image processing device and an image processing method in which an image memory section and various image processors are connected via a system bus and the various image processors execute the respective kinds of image data processing with access to an image memory.

A block matching technique to obtain a motion vector between two screens from image information itself is an old technique. Development has been advanced mainly about pan-and-tilt detection and subject tracking of a television camera, moving image encoding of the moving picture experts group (MPEG) system, and so forth. Furthermore, since the beginning of 1990s, application is being advanced about a wide variety of techniques based on image superposition, such as sensorless camera shake correction and noise removal (noise reduction, hereinafter represented as NR) in photographing under low illuminance.

The block matching is a method to calculate a motion vector between two screens, a reference screen as a screen of interest and an original screen (referred to as the target screen) as the origin of the motion of this reference screen. In the calculation of the motion vector between two screens, the correlation between the reference screen and the original screen is calculated about a block of a rectangular area having a predetermined size to thereby calculate the motion vector. There are the following both cases: the case in which the original screen is treated as a screen that is temporally earlier than the reference screen (e.g. the case of motion detection in the MPEG) and the case in which the reference screen is treated as a screen that is temporally earlier than the original screen (e.g. the case of noise reduction by superposition of image frames to be described later).

In this specification, the screen means an image that is composed of image data of one frame or one field and is displayed on a display as one image. However, for convenience of the following description in this specification, the screen will be often referred to as the frame based on the assumption that the screen is composed of one frame. For example, the reference screen will be often referred to as the reference frame and the original screen will be often referred to as the original frame.

In the block matching technique, the target frame is divided into plural target blocks and a search range is set in the reference frame for each target block. Then, a target block of the target frame and a reference block in the search range of the reference frame are read out from the image memory and the sum of absolute differences of the respective pixels is calculated. In the following, the sum of absolute differences will be referred to as the SAD value. When the SAD values are calculated, an SAD value table corresponding to the size of the search range is formed. The coordinate value of the minimum value of the SAD values in the SAD value table is treated as the motion vector about the target block.

The image memory to store image data when the block matching is performed is connected to a motion vector detector and so forth via a system bus, and writing and reading to and from the image memory are controlled by a memory controller.

In the block matching technique, the SAD value about data in units of the pixel from the image memory is calculated. Therefore, the number of times of access to the image memory becomes larger in proportion to the number of pixels of the image itself and the size of the search range and thus the bus band needs to be set wider. The bus band refers to an amount composed of a data rate, a bus width (bit number), and so forth with which data can be transferred with avoidance of congestion on a bus to transfer data. Widening of the bus band causes a problem that the system scale becomes larger and the cost increases.

To address this problem, there have been proposed e.g. a technique in which matching processing is not executed if the image state is a still state in which the image shows no motion, and a technique in which the amount of information is decreased by decimating the image of the reference frame.

As a method for reducing the bus band without lowering the block matching accuracy, a technique in which the common part of the reference block of the reference frame is retained and only the additional part is updated is effective.

However, there is a problem that these techniques lead to the lowering of the accuracy of the block matching and can be applied only to certain limited applications in which high accuracy is not required.

If the technique in which the common part of the reference block of the reference frame is retained and only the additional part is updated is employed, the bus band can be reduced without lowering the block matching accuracy. However, the order of the block subjected to the matching processing is important, and there is a problem that the bus band reduction cannot be achieved e.g. when the matching processing is not consecutively executed for adjacent blocks and when the order of the matching processing cannot be specified.

Furthermore, suppose that plural image data processors other than the block matching processor are connected to the image memory via the system bus. In this case, even if an efficient system for the block matching processing is employed as the way of memory access of image data to the image memory, this technique of memory access of image data to the image memory is not suitable for the other image data processors. There is a problem that possibly this technique causes increase in the bus band on the contrary about the other image data processors.

### SUMMARY

Japanese Patent Laid-open No. 2009-116763 proposes a technique in which output image data are written to two memory areas in units of two kinds of blocks that are different in the combination of the number of lines in the vertical direction of the image and the number of pixels along the horizontal direction. In this technique, both of a format suitable for data passing to a subsequent-stage circuit and a data format suitable for the block matching are prepared to thereby meet both requirements. However, the memory capacity on the dynamic random access memory (DRAM) is twice. Therefore, although the program relating to the bus band reduction is solved, problems about the memory capacity and the power consumption are newly caused.

The bus band and the memory capacity are in a close relationship. Reducing only one of them does not lead to system cost reduction and value is offered only when both are reduced.

There is a need for a technique to achieve reduction in the bus band and reduction in the memory capacity with avoidance of the above-described problems for the case in which plural image data processors are connected to an image memory via a system bus.

According to one embodiment of the present disclosure, there is provided an image processing device including an image processor configured to calculate a motion vector between image data of a target frame and image data of a reference frame in units of a block.

For processing by the image processor, the image processing device includes a reference frame image memory configured to retain image data of a past frame as the image data of the reference frame. Furthermore, the image processing device includes a primary memory configured to retain a matching processing range of the reference frame in calculation by the image processor. Moreover, the image processing device includes a secondary memory configured to read out and retain image data of a desired range from the image data of the reference frame stored in the reference frame image memory. The secondary memory reads out data of the matching processing range from the retained image data and supplies the read data to the primary memory. In addition, the image processing device includes data compressor and expander.

According to the embodiment of the present disclosure, the reference frame image memory configured by a high-capacity memory such as a DRAM can have such a configuration that data are recorded in a format and so forth that is convenient when stored image data are used in a subsequent-stage circuit. On the other hand, the primary memory is supplied with image data in the matching processing range via the secondary memory. Thus, by conversion on the secondary memory side, image data can be easily retained as image data of a format suitable for block matching. Furthermore, it is also possible to compress image data of the high-capacity memory and efficiently record the image data.

According to the embodiment of the present disclosure, data can be recorded in the reference frame image memory configured by a high-capacity memory in a format and so forth that is convenient when stored image data are used in a subsequent-stage circuit, and it is possible to compress the data and efficiently record the data for example. Furthermore, the primary memory receives supply of data converted to a format suitable for block matching by the secondary memory in advance, which makes it possible to efficiently execute block matching processing. Therefore, providing the secondary memory has an advantageous effect that both of enhancement in the recording efficiency of the reference frame image memory configured by a high-capacity memory and enhancement in the efficiency of acquisition processing of data for block matching processing in the primary memory are achieved and proper memory access can be performed.

### BRIEF DESCRIPTION OF THE DRAWINGS

FIG. 1 is a block diagram showing a configuration example of an imaging device as an image processing device according to one embodiment of the present disclosure;

FIG. 2 is a block diagram showing a configuration example of an automatic memory copying section according to one embodiment of the present disclosure;

FIG. 3 is an explanatory diagram showing an example of noise reduction processing for a taken image in the imaging device of one embodiment of the present disclosure;

FIG. 4 is an explanatory diagram showing an example of the noise reduction processing for a taken image in the imaging device of one embodiment of the present disclosure;

FIG. 5 is an explanatory diagram showing an example of a base plane and a reduced plane;

FIG. 6 is an explanatory diagram showing an example of the base plane and the reduced plane;

FIGS. 7A to 7C are explanatory diagrams showing an example of processing with the base plane and the reduced plane;

FIG. 8 is an explanatory diagram showing an operation example in a motion detection and motion compensation section in the imaging device of one embodiment of the present disclosure;

FIG. 9 is a block diagram showing a configuration example of the motion detection and motion compensation section in the imaging device of one embodiment of the present disclosure;

FIG. 10 is a block diagram of a detailed configuration example of part of the motion detection and motion compensation section of one embodiment of the present disclosure;

FIG. 11 is a block diagram of a detailed configuration example of part of the motion detection and motion compensation section of one embodiment of the present disclosure;

FIG. 12 is a block diagram showing a configuration example of an image superimposing section in the imaging device of one embodiment of the present disclosure;

FIG. 13 is a flowchart for explaining an image processing example in the imaging device of one embodiment of the present disclosure;

FIG. 14 is a flowchart for explaining the image processing example in the imaging device of one embodiment of the present disclosure;

FIG. 15 is a flowchart for explaining an image processing example in the imaging device of one embodiment of the present disclosure;

FIG. 16 is a flowchart for explaining a processing operation example of a motion vector calculator of one embodiment of the present disclosure;

FIG. 17 is a flowchart for explaining the processing operation example of the motion vector calculator of one embodiment of the present disclosure;

FIGS. 18A and 18B are explanatory diagrams showing a strip access form;

FIGS. 19A and 19B are explanatory diagrams showing a system of memory access of image data;

FIG. 20 is an explanatory diagram showing examples of the image processing unit;

FIGS. 21A and 21B are explanatory diagrams showing operation of memory access of image data;

FIG. 22 is an explanatory diagram showing operation of memory access of image data;

FIG. 23 is an explanatory diagram showing operation of memory access of image data;

FIG. 24 is an explanatory diagram showing operation of memory access of image data;

FIG. 25 is an explanatory diagram showing operation of memory access of image data;

FIG. 26 is an explanatory diagram showing operation of memory access of image data;

FIG. 27 is an explanatory diagram showing operation of memory access of image data;

FIGS. 28A and 28B are explanatory diagrams showing operation of memory access of image data;

FIG. 29 is an explanatory diagram showing operation of memory access of image data;

FIG. 30 is an explanatory diagram showing operation of memory access of image data;

FIG. 31 is a flowchart for explaining an image processing example according to one embodiment of the present disclosure;

FIG. 32 is a flowchart for explaining the image processing example according to one embodiment of the present disclosure;

FIG. 33 is a flowchart for explaining an image processing example according to one embodiment of the present disclosure;

FIG. 34 is an explanatory diagram showing a format example on a memory according to one embodiment of the present disclosure;

FIG. 35 is an explanatory diagram showing a format example on the memory according to one embodiment of the present disclosure;

FIGS. 36A and 36B are explanatory diagrams showing a change example of an area copied to the memory according to one embodiment of the present disclosure;

FIGS. 37A and 37B are explanatory diagrams showing a change example of an area copied to the memory according to one embodiment of the present disclosure; and

FIG. 38 is an explanatory diagram of comparison between processing of the example of one embodiment of the present disclosure and other examples.

### DETAILED DESCRIPTION OF THE PREFERRED EMBODIMENT

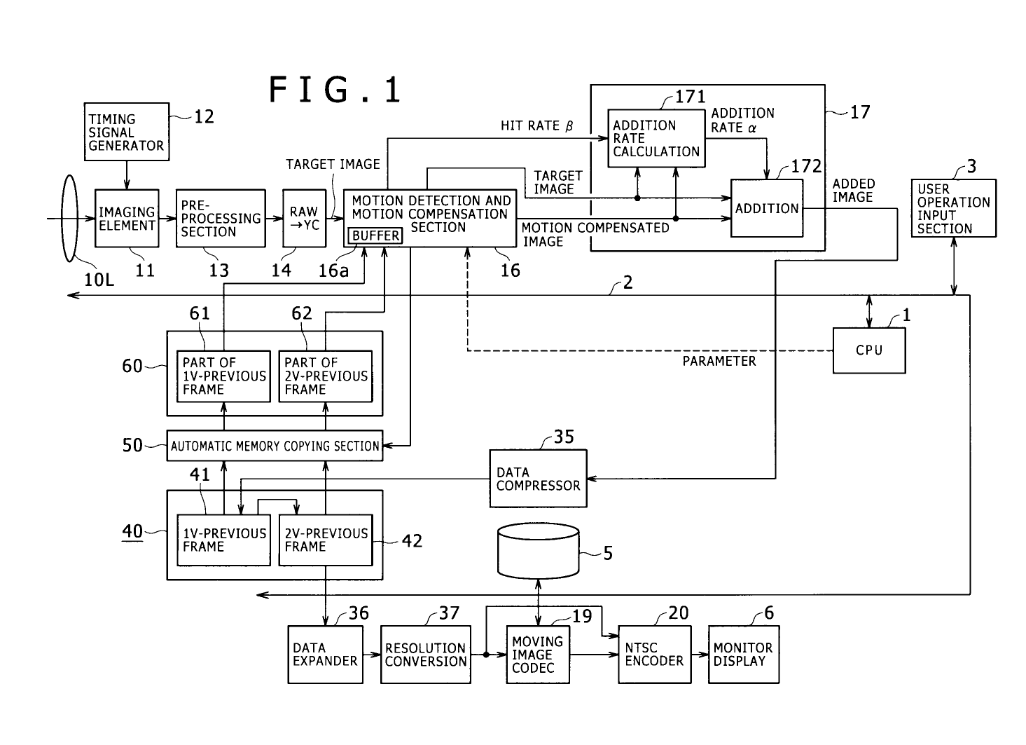

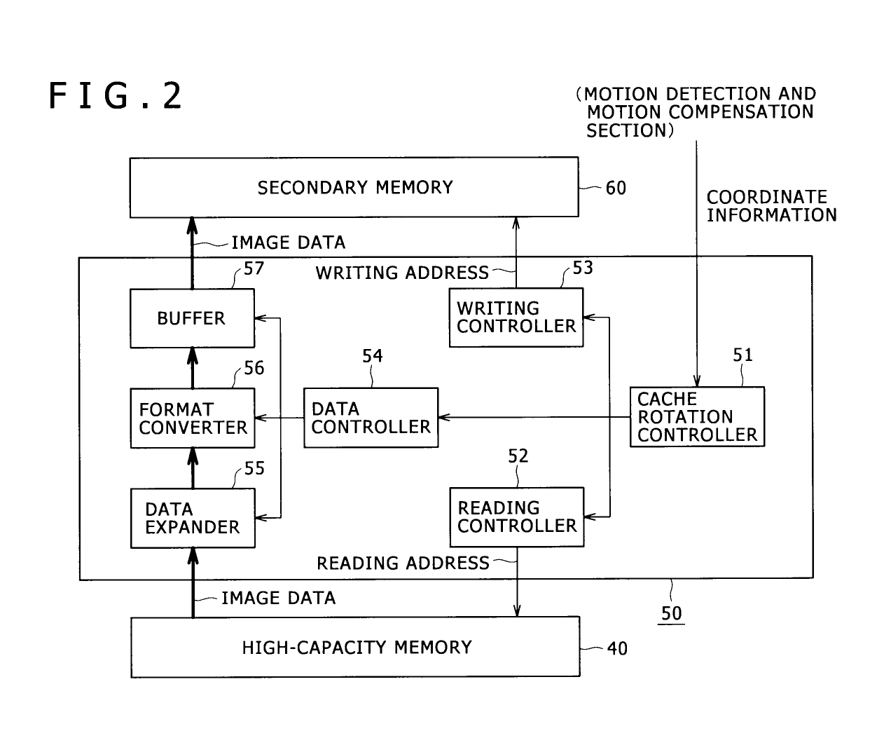

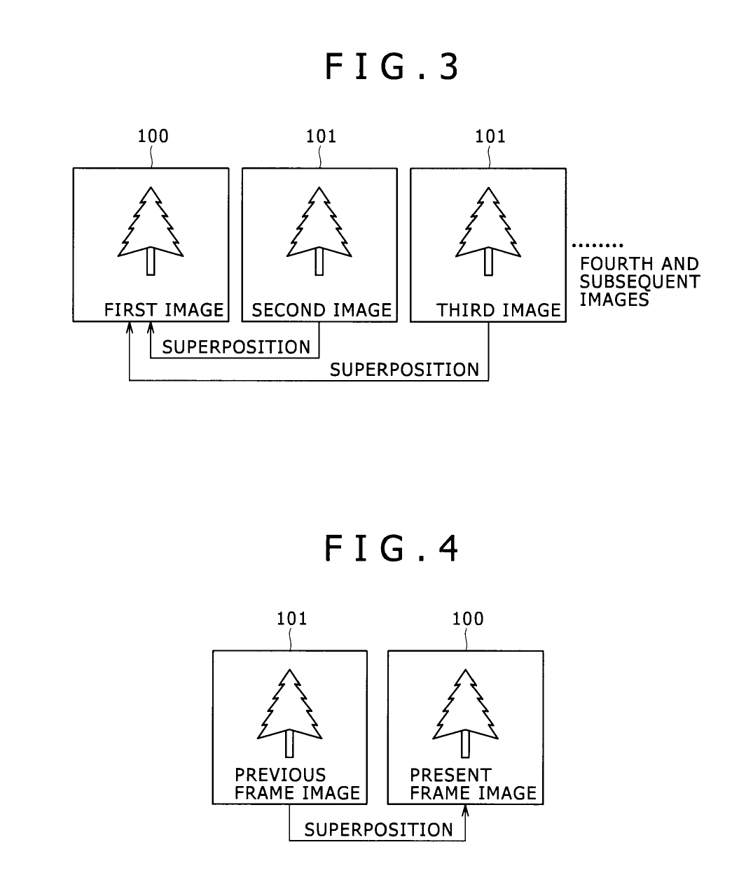

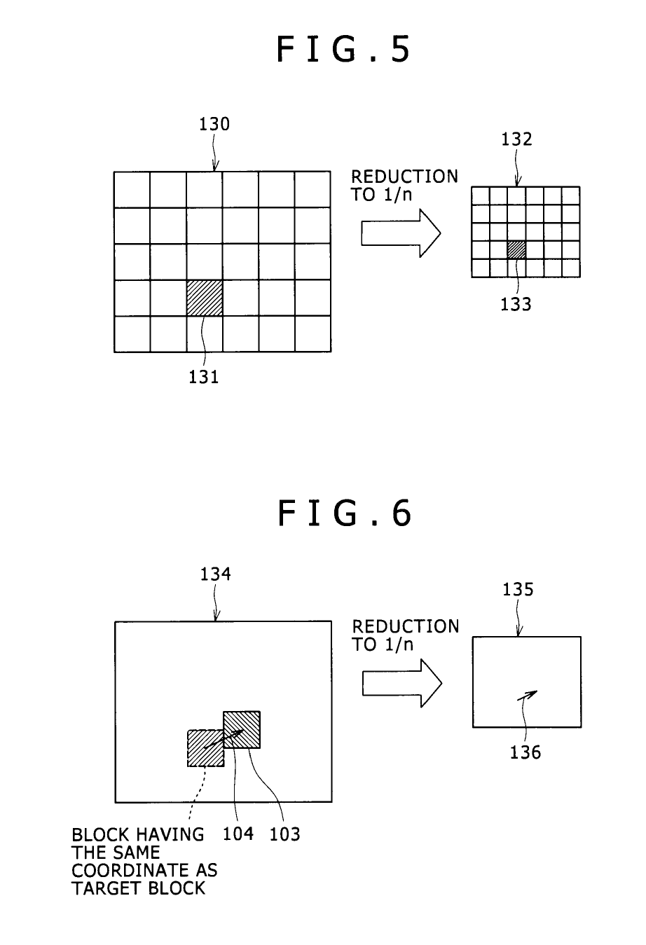

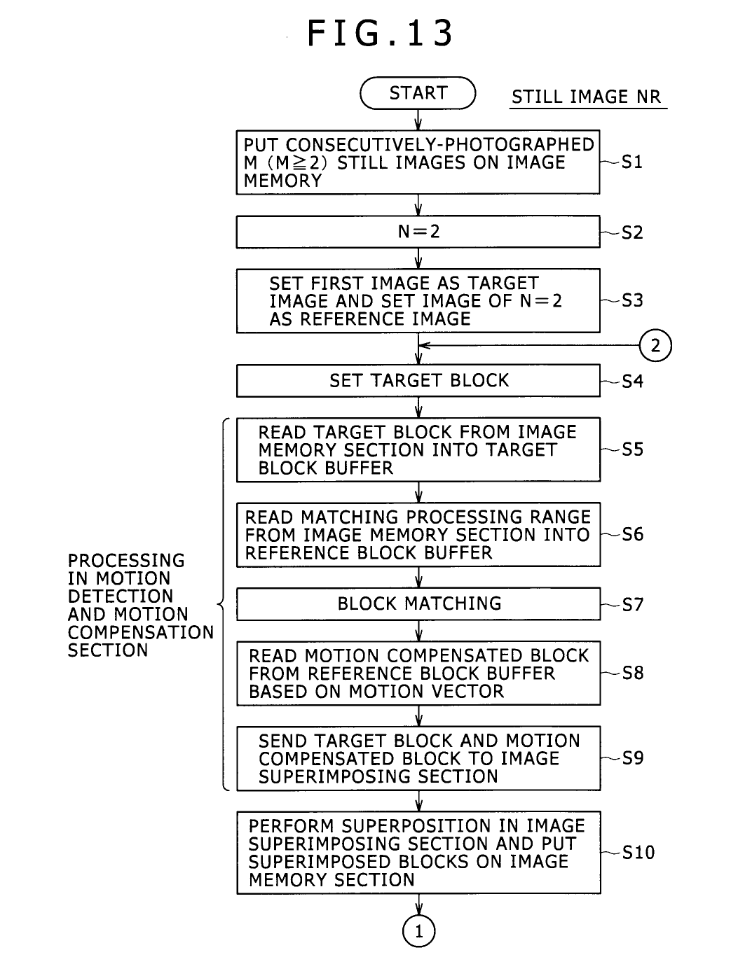

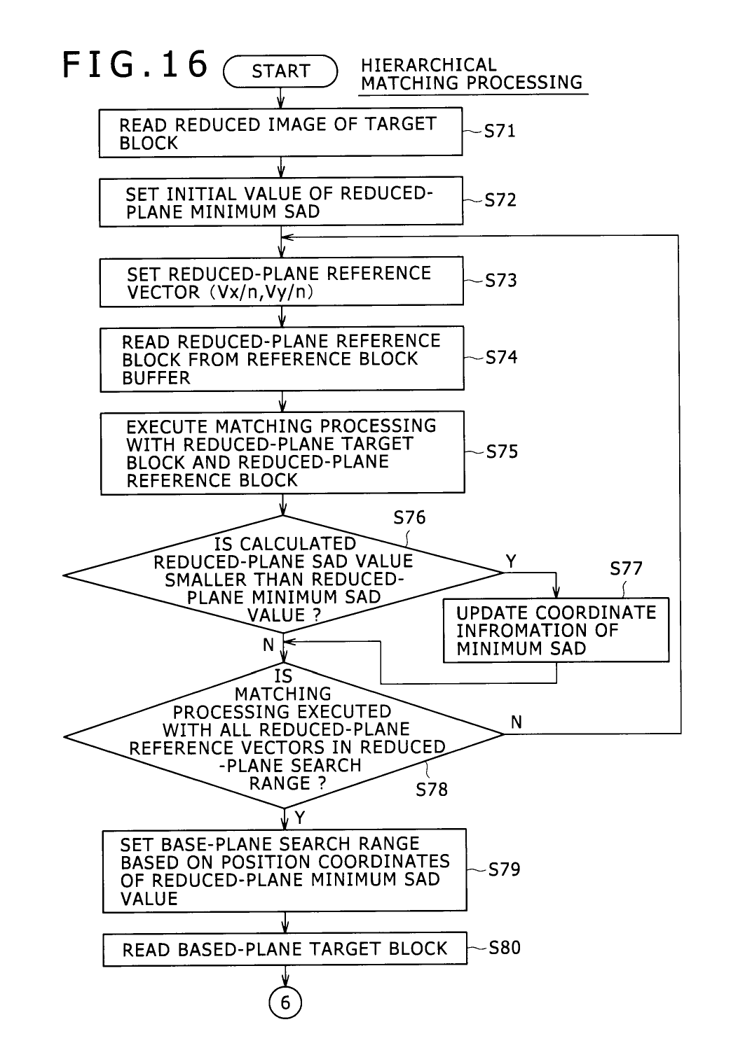

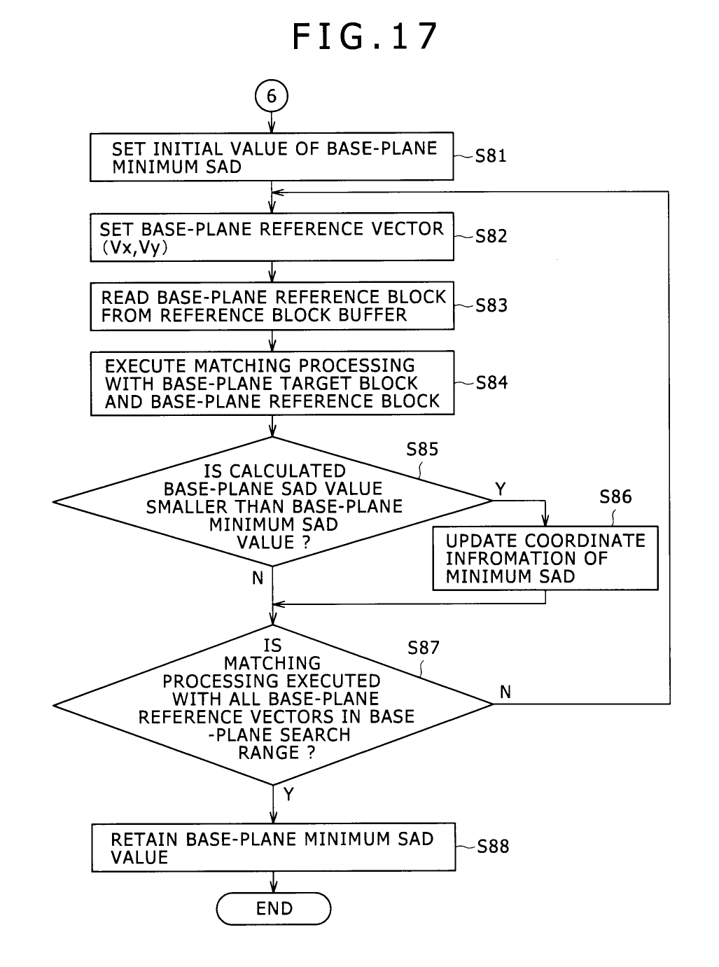

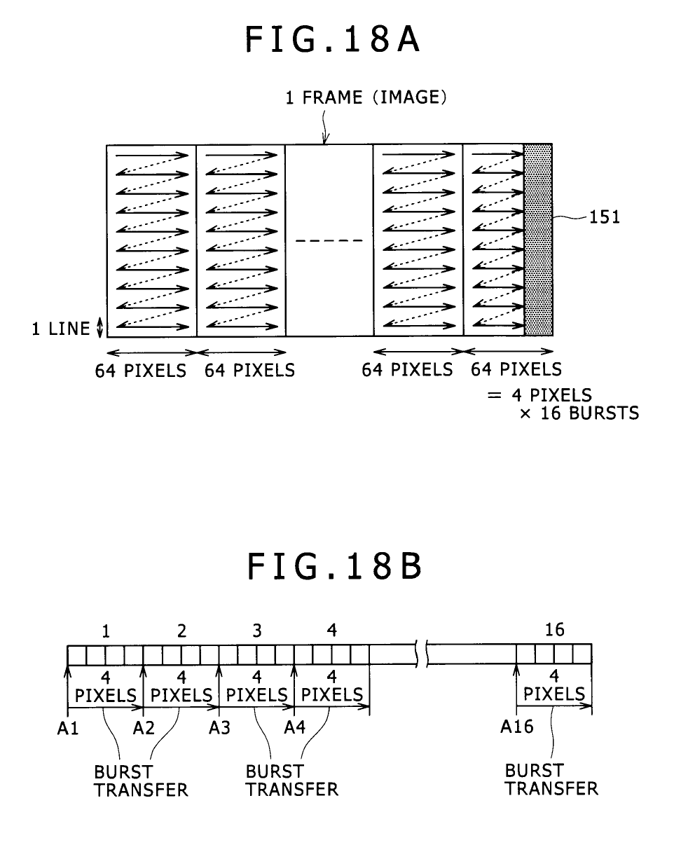

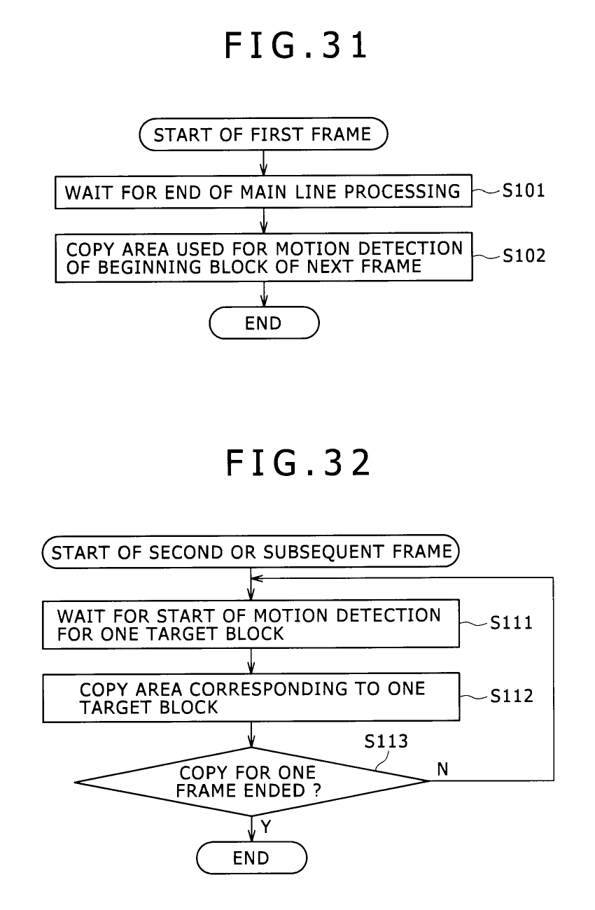

Examples of one embodiment of the present disclosure will be described below in the following order.
1. Configuration of Imaging Device (FIG. 1, FIG. 3, FIG. 4)
2. Configuration of Memory Copying Section (FIG. 2)
3. Description of Motion Detection and Motion Compensation Section (FIG. 5 to FIG. 12)
4. Flow of Noise Reduction Processing for Taken Image (FIG. 13 to FIG. 15)
5. Example of Flow of Hierarchical Block Matching Processing (FIG. 16 and FIG. 17)
6. Description of Format on Memory (FIG. 18A to FIG. 30)
7. Description of Processing with Use of Secondary Memory (FIG. 31 to FIG. 38)

### [1. Configuration of Imaging Device]

An image processing device according to an embodiment of this disclosure will be described below by taking an imaging device as an example with reference to the drawings.

The imaging device includes an image processor that executes image processing in which a motion vector between two screens is detected by block matching to generate a motion compensated image by using the detected motion vector and noise reduction is performed by superimposing the generated motion compensated image on the image as the noise reduction subject. First, the outline of this image processing will be described.

This example is so configured that an image in which noise is reduced can be obtained by performing alignment of consecutively-photographed plural images by using motion detection and motion compensation and then superimposing (adding) these images. That is, because noise in each of the plural images is at random, the images having the same content are superimposed and thus the noise is reduced for the image.

In the following, reducing noise by superimposing plural images by using motion detection and motion compensation will be referred to as NR (noise reduction) and an image in which noise is reduced by the NR will be referred to as the NR image.

Furthermore, in this specification, the screen (image) desired to be subjected to noise reduction is defined as the target screen (target frame) and the screen desired to be superimposed is defined as the reference screen (reference frame). Consecutively-photographed images involve deviation of the image position due to camera shake caused by the photographer and so forth, and alignment is important for superposition of both images. The point that should be considered is that the motion of the subject in the screen also exists as well as blurring of the whole screen, such as blurring due to camera shake.

In the imaging device of this example, in still image photographing, plural images are photographed at high speed and the first photographed image is treated as a target frame 100 as shown in FIG. 3. Furthermore, a predetermined number of photographed images as the second and subsequent images are treated as reference frames 101. The target frame 100 and the reference frames 101 are superimposed and the image resulting from the superposition is recorded as the photographed still image. That is, when the photographer carries out operation of pressing down the shutter button of the imaging device, the predetermined number of images are photographed at high speed. Furthermore, on the first photographed image (frame), the plural images (frames) photographed temporally later are superimposed.

In moving image photographing, as shown in FIG. 4, the image of the present frame output from the imaging element is treated as the image of the target frame 100 and the past image of the previous frame is treated as the image of the reference frame 101. Therefore, to perform noise reduction of the image of the present frame, the image of the previous frame of the present frame is superimposed on the present frame.

The configuration of the imaging device that carries out such movement detection and movement compensation will be described with reference to FIG. 1.

In the imaging device shown in FIG. 1, a central processing unit (CPU) 1 is connected to a system bus 2. In addition, an imaging signal processing system, a user operation input section 3, a high-capacity memory 40, a recording and reproduction device 5, and so forth are connected to the system bus 2. The CPU 1 is so defined as to include a read only memory (ROM) that stores programs to execute various kinds of software processing, a random access memory (RAM) for a work area, etc. although diagrammatic representation is omitted. This applies also to CPUs other than the CPU 1 described in the present specification.

The high-capacity memory 40 is composed of a memory having comparatively-high capacity, such as a DRAM, and a controller thereof, and is an image memory having capacity allowing storing of image data of one frame or plural frames. It is also possible to employ a configuration in which the controller of the memory is provided outside the memory 40 and writing and reading are controlled via the system bus 2 and so forth. In the following, the high-capacity memory 40 will be referred to as the image memory 40.

In response to operation for the start of imaging and recording via the user operation input section 3, the imaging signal processing system in the imaging device of FIG. 1 executes recording processing of taken image data to be described later. Furthermore, in response to operation for the start of reproduction of a taken-and-recorded image via the user output input section 3, the imaging signal processing system in the imaging device of FIG. 1 executes reproduction processing of taken image data recorded in a recording medium of the recording and reproduction device 5.

As shown in FIG. 1, as the imaging signal processing system, incident light from a subject via a camera optical system (not shown) including an imaging lens 10L is irradiated to an imaging element 11 and the image thereof is taken. In this example, the imaging element 11 is formed of a charge coupled device (CCD) imager. The imaging element 11 may be formed of another imager such as a complementary metal oxide semiconductor (CMOS) imager.

In the imaging device of this example, when the operation for the start of imaging and recording is carried out, video input via the lens 10L is converted to a taken image signal by the imaging element 11. This taken image signal is output as an analog imaging signal that is a RAW signal (raw signal) of the Bayer array composed of three primary colors, red (R), green (G), and blue (B), as a signal synchronized with a timing signal from a timing signal generator 12. The output analog imaging signal is supplied to a pre-processing section 13 and subjected to pre-processing such as defect correction and γ correction. The resulting signal is supplied to a data converter 14.

The data converter 14 converts the analog imaging signal, which is the RAW signal input thereto, to digital image data (YC data) composed of a luminance signal component Y and a color difference signal component Cb/Cr, and supplies the digital image data to a motion detection and motion compensation section 16 as the target image. In the motion detection and motion compensation section 16, the digital image data are stored in the area for the target image in a buffer memory 16a.

The motion detection and motion compensation section 16 acquires, as a reference image, the image signal of a previous frame that has been already written to the image memory 40 via an automatic memory copying section 50 and a secondary memory 60. The image data of the acquired reference image are stored in the area for the reference image in the buffer memory 16a of the motion detection and motion compensation section 16. A specific configuration example of the buffer memory 16a will be described later. This buffer memory 16a is used as an internal primary memory to be described later. In the following, the buffer memory 16a will be referred to as the primary memory or the internal primary memory.

The motion detection and motion compensation section 16 executes block matching processing to be described later by using the image data of the target frame and the image data of the reference frame and detects a motion vector in units of the target block. In the detection of the motion vector, a search of a reduced plane and a search of a base plane are performed. In the detection of the motion vector, a hit rate β indicating the detection accuracy of the motion vector is calculated and output.

Furthermore, in the motion detection and motion compensation section 16, a motion compensated image for which motion compensation is carried out on a block-by-block basis is generated based on the detected motion vector. The data of the generated motion compensated image and the original target image are supplied to an addition rate calculator 171 and an adder 172 configuring an image superimposing section 17.

The addition rate calculator 171 calculates an addition rate α of addition of the target image and the motion compensated image based on the hit rate β and supplies the calculated addition rate α to the adder 172.

The adder 172 executes addition processing of the data of the target image and the data of the motion compensated image with the addition rate α and executes image superposition processing to obtain an added image in which noise is reduced. In the following, the added image in which noise is reduced will be referred to as the NR image.

The image data of the added image in which noise is reduced as the superposition result output by the adder 172 are subjected to data compression by a data compressor 35 and then stored in the image memory 40.

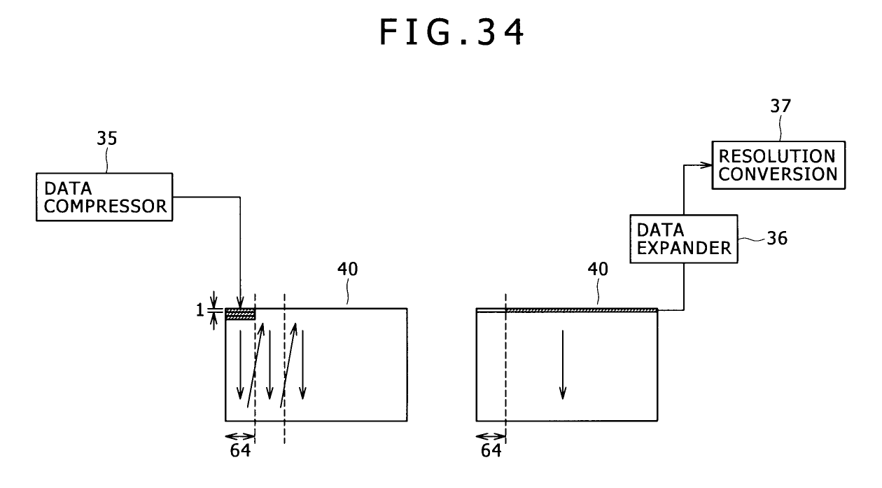

The data compressor 35 executes compression processing for efficiently storing data in the image memory 40. In this example, the data compressor 35 divides the image data of one frame into image data in units of the target block for execution of the block matching processing in the motion detection and motion compensation section 16, and executes the compression processing for the image data in units of the target block. In this compression processing, the data in units of one target block are further divided on each one line basis and the data in units of one line are subjected to compression processing. Examples of the division for the compression processing will be described later (FIG. 34 and so forth).

The image memory 40 stores and retains the data of the NR image that results from the compression processing and corresponds to one frame in a 1V-previous frame storage 41 in the image memory 40. The image memory 40 includes a 2V-previous frame storage 42 besides the 1V-previous frame storage 41 and stored data are moved from the 1V-previous frame storage 41 to the 2V-previous frame storage 42 every one-frame cycle. In conjunction with this movement of the stored data from the 1V-previous frame storage 41 to the 2V-previous frame storage 42, the data stored in the 2V-previous frame storage 42 are read out to a data expander 36.

In the configuration of FIG. 1, image data of two frames are stored. However, if more past image data are used in the motion detection and motion compensation section 16 and so forth, past image data of a larger number of frames may be stored and used as the reference frame.

The data expander 36 executes processing of expanding the image data compressed in the data compressor 35 to the original data when the image data are stored in the image memory 40. That is, processing of expanding the image data compressed in units of the target block in the data compressor 35 is executed. The video data expanded by the data expander 36 is supplied to a resolution converter 37. The resolution converter 37 converts the data to image data having a resolution for displaying or for output. If the converted image data are recorded in the recording and reproduction device 5, the image data are converted by a moving image codec 19. The image data converted by the moving image codec 19 are recorded in a recording medium in the recording and reproduction device 5 and are read out from the recording medium in the recording and reproduction device 5 according to need.

The image data output by the resolution converter 37 or the image data reproduced by the recording and reproduction device 5 are supplied to an NTSC (national television system committee) encoder 20. The image data are converted to a standard color video signal of the NTSC system by this NTSC encoder 20 and supplied to a monitor display 6 formed of e.g. a liquid crystal display panel. By this supply to the monitor display 6, a monitor image is displayed on the display screen of the monitor display 6. The output video signal from the NTSC encoder 20 can be derived to the external via a video output terminal although diagrammatic representation is omitted in FIG. 1.

Part of the image data stored in the image memory 40 is read out to be supplied to the secondary memory 60 and stored therein under control by the automatic memory copying section 50. The automatic memory copying section 50, whose configuration will be described later, has a format converter 56 for the image data.

The secondary memory 60 includes a partial storage 61 for the 1V-previous frame and a partial storage 62 for the 2V-previous frame. Stored data of the respective storages 61 and 62 are supplied to the motion detection and motion compensation section 16 and used as the data in the search range of the reference frame. The primary memory 16a and the secondary memory 60 are e.g. a memory embedded in (or connected to) the image processor configuring the motion detection and motion compensation section 16 and are formed of e.g. a static random access memory (SRAM).

### [2. Configuration of Memory Copying Section]

FIG. 2 is a diagram showing the configuration of the automatic memory copying section 50 of the example of the present embodiment.

In the automatic memory copying section 50, the coordinate information of the search range is supplied from the motion detection and motion compensation section 16 to a cache rotation controller 51. Based on the coordinate information of the search range, the address of reading from the image memory 40 and the address of writing to the secondary memory 60 are generated. The generated reading address is supplied from a reading controller 52 to the image memory 40 and reading is performed. The generated writing address is supplied from a writing controller 53 to the secondary memory 60 and writing is performed.

The image data themselves read out from the image memory 40 are transferred under control by a data controller 54. Specifically, the image data read out from the image memory 40 are supplied to a data expander 55 and the image data compressed in writing to the image memory 40 are subjected to expansion processing. This expansion processing in the data expander 55 is executed based on the same data unit as that in the compression. For the image data resulting from the expansion processing, format conversion to image data having a data arrangement (pixel arrangement) suitable for processing in the motion detection and motion compensation section 16 is performed in a format converter 56. The image data resulting from the format conversion are temporarily accumulated in a buffer memory 57 and then written to the secondary memory 60 in synchronization with an instruction by the writing controller 53.

### [3. Description of Motion Detection and Motion Compensation Section]

The motion detection and motion compensation section 16 performs motion vector detection by executing block matching processing with use of the SAD value, which is the sum of absolute differences.

### <Outline of Hierarchical Block Matching Processing>

In motion vector detection processing in general block matching, the reference block is moved in units of the pixel (in units of one pixel or plural pixels) and the SAD value about the reference block at each movement position is calculated. Then, the SAD value showing the minimum value is detected from the calculated SAD values and the motion vector is detected based on the reference block position presenting this minimum SAD value.

However, in this motion vector detection processing, the number of times of the matching processing to calculate the SAD value becomes larger in proportion to the search range because the reference block is moved on a pixel-by-pixel basis in the search range. This causes a problem that the matching processing time becomes long and the size of the SAD table also becomes large.

So, in this example, reduced images are created for the target image (target frame) and the reference image (reference frame) and block matching is performed with the created reduced images. Based on the result of the motion detection with the reduced images, block matching with the original target image is performed. The reduced image will be referred to as the reduced plane and the original image that is not reduced will be referred to as the base plane. Therefore, in this example, after block matching with the reduced planes is performed, block matching with the base planes is performed by using the matching result.

FIG. 5 and FIG. 6 show the notion of image reduction of the target frame (image) and the reference frame (image). Specifically, in this example, as shown in FIG. 5 for example, a base-plane target frame 130 is converted to a reduced-plane target frame 132 by reducing the size to 1/n (n is a positive number) in each of the horizontal direction and the vertical direction. Therefore, a base-plane target block 131 generated by dividing the base-plane target frame 130 into plural blocks becomes a reduced-plane target block 133 obtained by reducing the size to 1/n in each of the horizontal direction and the vertical direction in the reduced-plane target frame.

Furthermore, the reference frame is reduced in accordance with the image reduction rate 1/n of the target frame. Specifically, as shown in FIG. 6, a base-plane reference frame 134 is converted to a reduced-plane reference frame 135 by reducing the size to 1/n in each of the horizontal direction and the vertical direction. A motion vector 104 about a motion compensated block 103 detected on the base-plane reference frame 134 is detected as a reduced-plane motion vector 136 obtained by reduction to 1/n×1/n in the reduced-plane reference frame 135.

In the above-described example, the image reduction rate of the target frame is set equal to that of the reference frame. However, to reduce the amount of calculation, image reduction rates that are different between the target frame (image) and the reference frame (image) may be used and matching may be so performed that the numbers of pixels of both frames are set identical to each other through processing of e.g. pixel interpolation.

Although the reduction rates of the horizontal direction and the vertical direction are set equal to each other, the reduction rate of the horizontal direction may be different from that of the vertical direction. For example, if the size is reduced to 1/n in the horizontal direction and the size is reduced to 1/m (m is a positive number, n≠m) in the vertical direction, the reduced screen has the size of 1/n×1/m of the original screen.

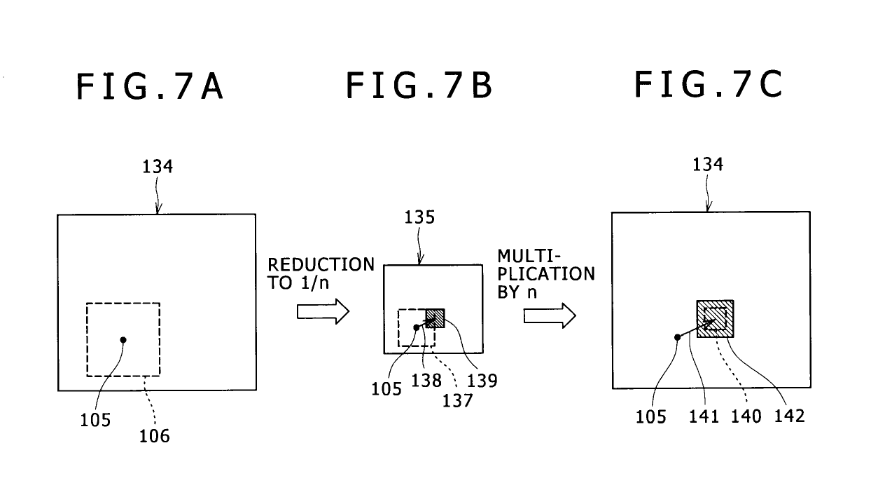

FIGS. 7A to 7C show the relationship between a reduced-plane reference vector and a base-plane reference vector. Suppose that a motion detection origin 105 and a search range 106 are decided as shown in FIG. 7A in the base-plane reference frame 134. In this case, on the reduced-plane reference frame 135 obtained by image reduction to 1/n×1/n, the search range is a reduced-plane search range 137 obtained by reduction to 1/n×1/n as shown in FIG. 7B.

In this example, in the reduced-plane search range 137, a reduced-plane reference vector 138 representing the amount of position deviation from the motion detection origin 105 in the reduced-plane reference frame 135 is set. Furthermore, the correlation between a reduced-plane reference block 139 at the position indicated by each reduced-plane reference vector 138 and the reduced-plane target block 133 (not shown in FIGS. 7A to 7C) is evaluated.

In this case, because the block matching is performed in the reduced image, the number of reduced-plane reference block positions (reduced-plane reference vectors) about which the SAD value should be calculated in the reduced-plane reference frame 135 can be decreased. Corresponding to this decrease in the number of times of calculation of the SAD value (the number of times of matching processing), the speed of the processing can be enhanced and the scale of the SAD table can be reduced.

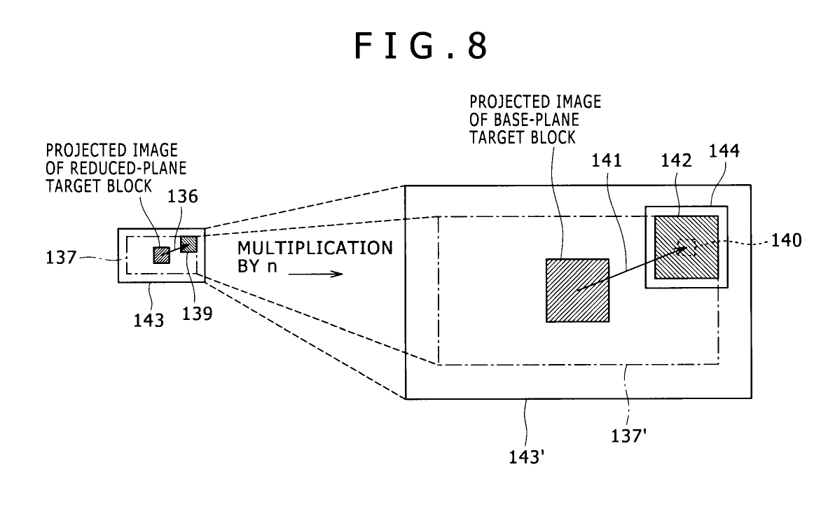

As shown in FIG. 8, a correlation evaluation by block matching between the plural reduced-plane reference blocks 139 set in a reduced-plane matching processing range 143 defined depending on the reduced-plane search range 137 and the reduced-plane target block 133 is obtained. By this correlation evaluation, the reduced-plane motion vector 136 in the reduced-plane reference frame 135 is calculated. The accuracy of this reduced-plane motion vector 136 is low accuracy equivalent to 1/n of the one-pixel accuracy because the image is reduced to 1/n×1/n. So, even if this calculated reduced-plane motion vector 136 is multiplied by n, the motion vector 104 of the one-pixel accuracy is not obtained in the base-plane reference frame 134.

However, it is apparent that, in the base-plane reference frame 134, the base-plane motion vector 104 of the one-pixel accuracy exists near the motion vector obtained by multiplying the reduced-plane motion vector 136 by n.

So, in this example, as shown in FIG. 7C and FIG. 8, the position indicated by the motion vector obtained by multiplying the reduced-plane motion vector 136 by n (base-plane reference vector 141) is considered as the center in the base-plane reference frame 134. A base-plane search range 140 is so set that this position is defined as the center, in a small range in which the base-plane motion vector 104 will exist, and a base-plane matching processing range 144 is set depending on the set base-plane search range 140.

Furthermore, as shown in FIG. 7C, the base-plane reference vector 141 in the base-plane reference frame 134 is set as a vector indicating a position in this base-plane search range 140, and a base-plane reference block 142 is set at the position indicated by each base-plane reference vector 141. Based on these kinds of setting, block matching in the base-plane reference frame 134 is performed.

The base-plane search range 140 and the base-plane matching processing range 144 set in this example may be very small ranges. Specifically, as shown in FIG. 8, they may be very small ranges compared with a search range 137′ and a matching processing range 143′ obtained by multiplying the reduced-plane search range 137 and the reduced-plane matching processing range 143 by n, which is the inversion of the reduction rate.

Therefore, if block matching processing is executed only in the base plane without performing the hierarchical matching, plural reference blocks need to be set in the search range 137′ and the matching processing range 143′ in the base plane and calculation to obtain the correlation with the target block needs to be performed. In contrast, in the hierarchical matching processing, it is enough that matching processing is executed only in a very small range as shown in FIG. 8.

Therefore, the number of base-plane reference blocks set in the base-plane search range 140 and the base-plane matching processing range 144, which are the small ranges, is very small. Thus, the number of times of matching processing (the number of times of correlation calculation) and the number of retained SAD values can be set very small. Accordingly, the advantageous effects that the speed of the processing can be enhanced and the scale of the SAD table can be reduced can be achieved.

### <Configuration Example of Motion Detection and Motion Compensation Section>

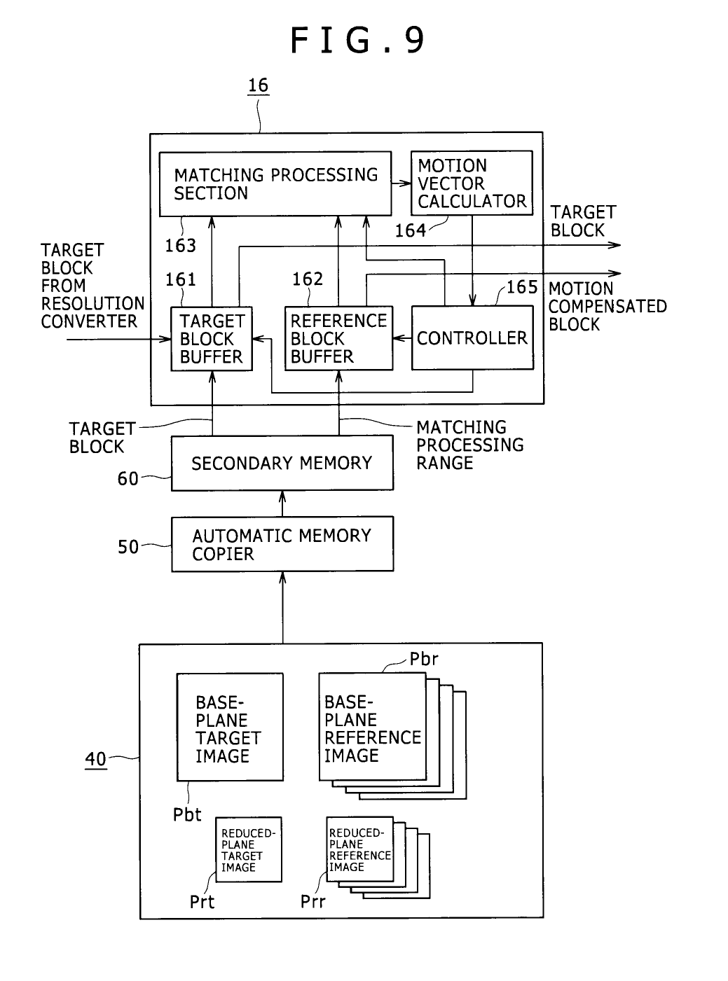

FIG. 9 shows a block diagram of a configuration example of the motion detection and motion compensation section 16. In this example, the motion detection and motion compensation section 16 includes a target block buffer 161 that retains pixel data of a target block 102 and a reference block buffer 162 that retains pixel data of a reference block 108. These buffers 161 and 162 are equivalent to the buffer (primary memory) 16a shown in FIG. 1.

Furthermore, the motion detection and motion compensation section 16 includes a matching processing section 163 to calculate the SAD value about the pixels that correspond between the target block 102 and the reference block 108. Moreover, the motion detection and motion compensation section 16 includes a motion vector calculator 164 that calculates a motion vector from SAD value information output from the matching processing section 163 and a controller 165 that controls the respective blocks.

Image data stored in the image memory 40 are supplied to the target block buffer 161 and the reference block buffer 162 in the motion detection and motion compensation section 16 via the automatic memory copying section 50 and the secondary memory 60.

When a still image is taken, the following images are read out from the image memory 40 and written to the target block buffer 161 in accordance with reading control by a memory controller 8. Specifically, a reduced-plane target block or a base-plane target block from the image frame of a reduced-plane target image Prt or a base-plane target image Pbt stored in the image memory 40 is read out from the image memory 40 and written.

As the first image of the reduced-plane target image Prt or the base-plane target image Pbt, the image of the first imaged frame after the shutter button is pressed down is read out from the image memory 40 and written to the target block buffer 161 as a target frame 102. When images are superimposed based on block matching with the reference image, the NR image resulting from this image superposition is written to the image memory 40 and the target frame 102 in the target block buffer 161 is rewritten to this NR image.

To the reference block buffer 162, image data in a reduced-plane matching processing range or a base-plane matching processing range from the image frame of a reduced-plane reference image Prr or a base-plane reference image Pbr stored in the image memory 40 are written. As the reduced-plane reference image Prr or the base-plane reference image Pbr, an imaged frame subsequent to the first imaged frame is written to the image memory 40 as a reference frame 108.

In this case, in the case of executing image superposition processing with capturing of consecutively-photographed plural taken images, imaged frames subsequent to the first imaged frame are sequentially captured into the image memory 40 one by one as the base-plane reference image and the reduced-plane reference image.

If motion vector detection and image superposition are carried out in the motion detection and motion compensation section 16 and the image superimposing section 17 after consecutively-photographed plural taken images are captured into the image memory 40, plural imaged frames should be retained. This processing after consecutively-photographed plural taken images are captured into the image memory 40 will be referred to as after-photographing addition. That is, in this after-photographing addition, all of plural imaged frames subsequent to the first imaged frame should be stored and retained in the image memory 40 as the base-plane reference image and the reduced-plane reference image.

The imaging device can use either in-photographing addition or after-photographing addition. However, this embodiment employs processing of the after-photographing addition in consideration of a request for the still image NR processing to provide a high-quality image in which noise is reduced in spite of a somewhat long processing time.

In moving image photographing, an imaged frame from an image correction and resolution conversion section 15 is input to the motion detection and motion compensation section 16 as the target frame 102. To the target block buffer 161, a target block extracted from the target frame from this image correction and resolution conversion section 15 is written. Furthermore, the imaged frame that is one-previous to the target frame and stored in an image memory section 4 is set as the reference frame 108. To the reference block buffer 162, the base-plane matching processing range or the reduced-plane matching processing range from this reference frame (base-plane reference image Pbr or reduced-plane reference image Prr) is written.

In this moving image photographing, at least the one-previous taken image frame with which block matching should be performed with the target frame from the image correction and resolution conversion section 15 is retained in the image memory 40 as the base-plane reference image Pbr and the reduced-plane reference image Prr.

The matching processing section 163 executes matching processing in the reduced plane and matching processing in the base plane about the target block stored in the target block buffer 161 and the reference block stored in the reference block buffer 162.

Here, a consideration will be made below about the case in which the data stored in the target block buffer 161 are the image data of the reduced-plane target block and the data stored in the reference block buffer 162 are the image data in the reduced-plane matching processing range extracted from the reduced-plane reference screen. In this case, the matching processing section 163 executes reduced-plane matching processing. Furthermore, the data stored in the target block buffer 161 become the image data of the base-plane target block. If the data stored in the reference block buffer 162 are the image data in the base-plane matching processing range extracted from the base-plane reference screen, the matching processing section 163 executes base-plane matching processing.

In order for the matching processing section 163 to detect the strength of the correlation between the target block and the reference block in block matching, the SAD values are calculated by using luminance information of image data. Then, the minimum SAD value is detected and the reference block presenting this minimum SAD value is detected as the strongest-correlation reference block.

It is obvious that not the luminance information but the color difference signal or information of three primary signals R, G, and B may be used for the calculation of the SAD value. Furthermore, normally all pixels in the block are used for the calculation of the SAD value. However, to reduce the amount of calculation, only the pixel value of limited pixels at intermittent positions may be used through e.g. decimation.

The motion vector calculator 164 detects the motion vector of the reference block with respect to the target block from the result of the matching processing of the matching processing section 163. In this example, the motion vector calculator 164 detects and retains the minimum value of the SAD value.

The controller 165 controls the processing operation of the hierarchical block matching processing in the motion detection and motion compensation section 16 under control by the CPU 1.

### <Configuration Example of Target Block Buffer>

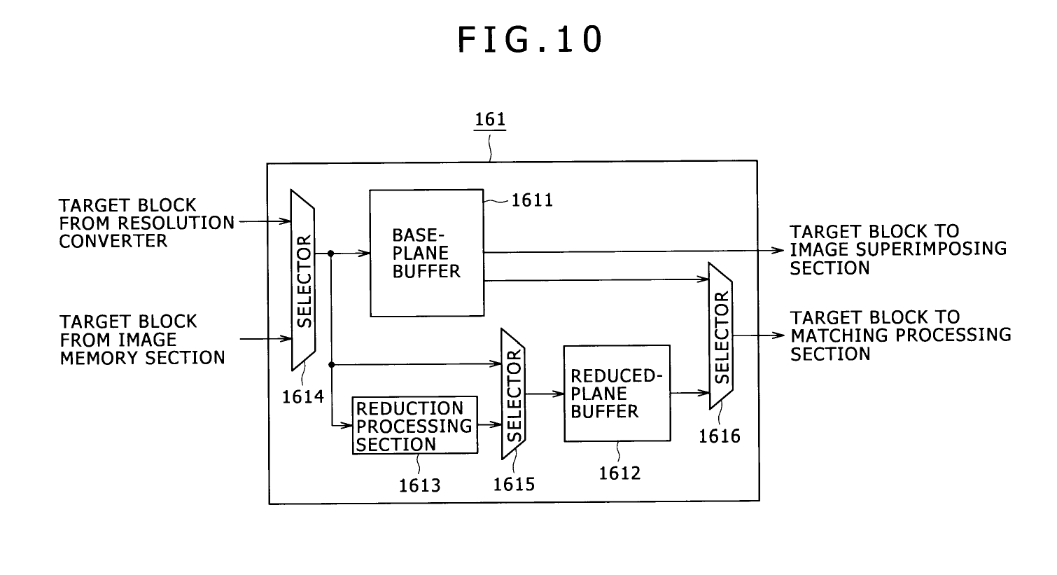

FIG. 10 shows a block diagram of a configuration example of the target block buffer. As shown in FIG. 10, the target block buffer 161 includes a base-plane buffer 1611, a reduced-plane buffer 1612, a reduction processing section 1613, and selectors 1614, 1615, and 1616. Selection of each of the selectors 1614, 1615, and 1616 is controlled by a selection control signal from the controller 165 although diagrammatic representation is omitted in FIG. 10.

The base-plane buffer 1611 is to temporarily store the base-plane target block. This base-plane buffer 1611 sends the base-plane target block to the image superimposing section 17 and supplies it to the selector 1616.

The reduced-plane buffer 1612 is to temporarily store the reduced-plane target block. The reduced-plane buffer 1612 supplies the reduced-plane target block to the selector 1616.

In moving image photographing, the target block is sent from the image correction and resolution conversion section 15 as described above. Thus, the reduction processing section 1613 is provided to generate the reduced-plane target block. The reduced-plane target block from the reduction processing section 1613 is supplied to the selector 1615.

The selector 1614 outputs the target block (base-plane target block) from the data converter 14 in moving image photographing. It outputs the base-plane target block or the reduced-plane target block read out from the image memory 40 in still image photographing. These outputs are selected by the selection control signal from the controller 165 and the output is supplied to the base-plane buffer 1611, the reduction processing section 1613, and the selector 1615.

The selector 1615 selects and outputs the reduced-plane target block from the reduction processing section 1613 in moving image photographing and the reduced-plane target block from the image memory 40 in still image photographing, in accordance with the selection control signal from the controller 165. The output is supplied to the reduced-plane buffer 1612.

The selector 1616 outputs the reduced-plane target block from the reduced-plane buffer 1612 in block matching in the reduced plane in accordance with the selection control signal from the controller 165. It outputs the base-plane target block from the base-plane buffer 1611 in block matching in the base plane. The output reduced-plane target block or the base-plane target block is sent to the matching processing section 163.

### <Configuration Example of Reference Block Buffer>

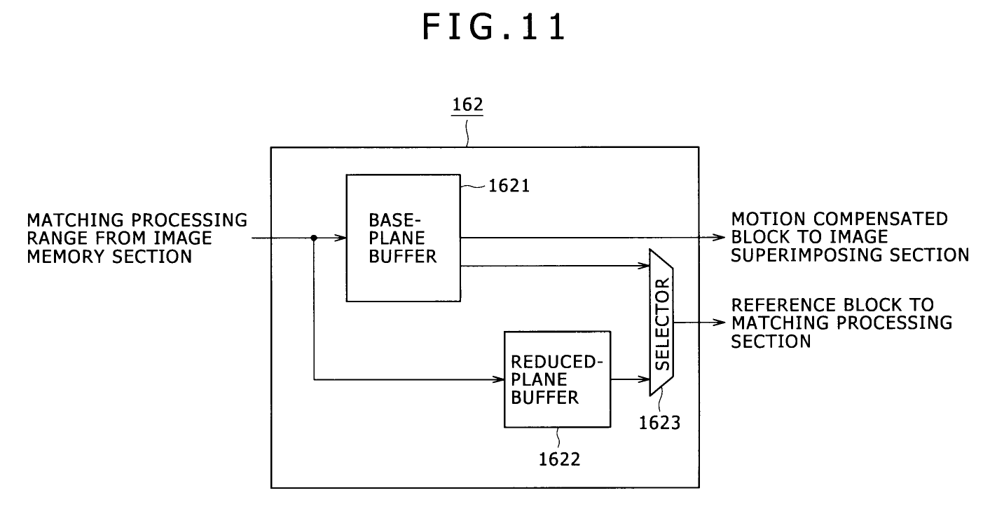

FIG. 11 shows a block diagram of a configuration example of the reference block buffer 162. As shown in FIG. 11, the reference block buffer 162 includes a base-plane buffer 1621, a reduced-plane buffer 1622, and a selector 1623. Selection of the selector 1623 is controlled by a selection control signal from the controller 165 although diagrammatic representation is omitted in FIG. 11.

The base-plane buffer 1621 temporarily stores the base-plane reference block from the image memory 40. The base-plane buffer 1621 supplies the base-plane reference block to the selector 1623 and sends it to the image superimposing section 17 as a motion compensated block.

The reduced-plane buffer 1622 is to temporarily store the reduced-plane reference block from the image memory 40. The reduced-plane buffer 1622 supplies the reduced-plane reference block to the selector 1623.

The selector 1623 outputs the reduced-plane reference block from the reduced-plane buffer 1622 in block matching in the reduced plane in accordance with the selection control signal from the controller 165. It outputs the base-plane reference block from the base-plane buffer 1621 in block matching in the base plane. The output reduced-plane reference block or the base-plane reference block is sent to the matching processing section 163.

### <Configuration Example of Image Superimposing Section>

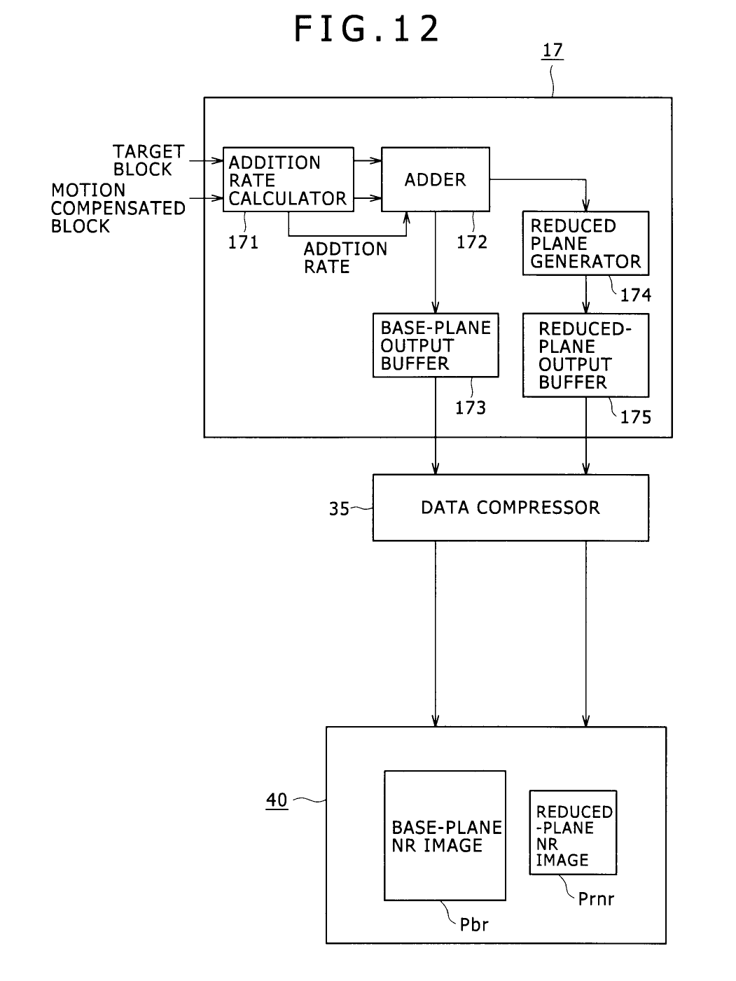

FIG. 12 shows a block diagram of a configuration example of the image superimposing section 17. As shown in FIG. 12, the image superimposing section 17 includes the addition rate calculator 171, the adder 172, a base-plane output buffer 173, a reduced plane generator 174, and a reduced-plane output buffer 175.

Output image data of the image superimposing section 17 are compressed by the data compressor 35 and then stored in the image memory 40.

The addition rate calculator 171 receives the target block and the motion compensated block from the motion detection and motion compensation section 16 and defines the addition rate of both depending on whether the employed addition system is the simple addition system or the average addition system. The defined addition rate is supplied to the adder 172 together with the target block and the motion compensated block.

The base-plane NR image as the addition result by the adder 172 is compressed and then written to the image memory 40. Furthermore, the base-plane NR image as the addition result by the adder 172 is converted to a reduced-plane NR image in the reduced plane generator 174 and the reduced-plane NR image from the reduced plane generator 174 is written to the image memory 40.

### [4. Flow of Noise Reduction Processing for Taken Image]

### <Still Image Photographing>

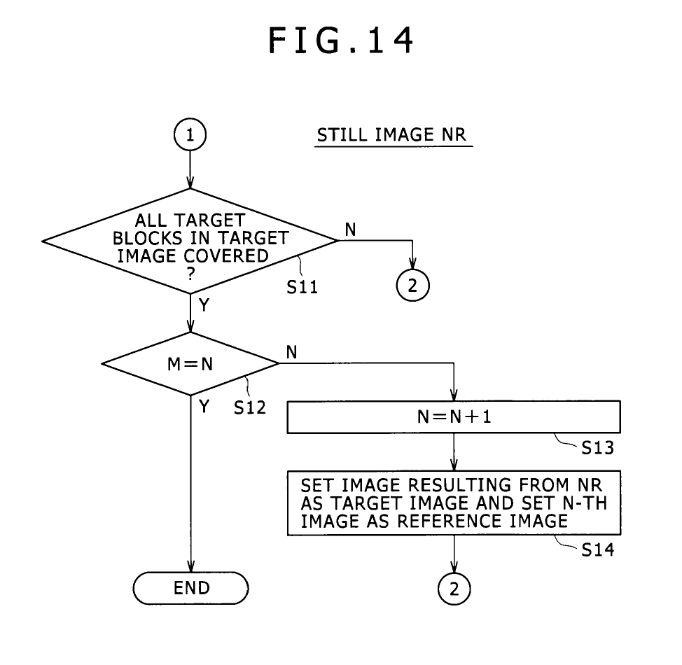

FIG. 13 and FIG. 14 show flowcharts of noise reduction processing by image superposition in still image photographing in the imaging device of the embodiment having the above-described configuration. The respective steps in the flowcharts of FIG. 13 and FIG. 14 are carried out under control by the CPU 1 and the controller 165 of the motion detection and motion compensation section 16 controlled by this CPU 1 and carried out by the image superimposing section 17.

First, when the shutter button is pressed down, in the imaging device of this example, plural images are photographed at high speed under control by the CPU 1. In this example, M taken image data (M frames, M is an integer equal to or larger than two) that should be superimposed on each other in still image photographing are captured at high speed and put on the image memory 40 (step S1).

Next, as the reference frame, the temporally N-th image frame (N is an integer equal to or larger than two and its maximum value is M) among M image frames accumulated in the image memory 40 is set. The controller 165 sets the initial value of N, which defines the order of the frame, to two (N=2) (step S2). Next, the controller 165 sets the first image frame as the target image (target frame) and sets the image of N=2 as the reference image (reference frame) (step S3).

Next, the controller 165 sets a target block in the target frame (step S4) and the target block is read from the image memory section 4 into the target block buffer 161 in the motion detection and motion compensation section 16 (step S5). Furthermore, the pixel data in the matching processing range are read from the image memory section 4 into the reference block buffer 162 (step S6).

Next, the controller 165 reads out a reference block in the search range from the reference block buffer 162 and the matching processing section 163 executes hierarchical matching processing. After the above-described processing is repeated with all reference vectors in the search range, the high-accuracy base-plane motion vector is output (step S7).

Next, in accordance with the high-accuracy base-plane motion vector detected in the above-described manner, the controller 165 reads out a motion compensated block obtained by compensating motion corresponding to the detected motion vector from the reference block buffer 162 (step S8). Then, the controller 165 sends the motion compensated block to the image superimposing section 17 at the subsequent stage in synchronization with the target block (step S9).

Next, in accordance with control by the CPU 1, the image superimposing section 17 performs superposition of the target block and the motion compensated block and puts the NR image data of the superimposed blocks on the image memory section 4. That is, the image superimposing section 17 makes the NR image data of the superimposed blocks be output to the side of the image memory 40 and written thereto (step S10).

Next, the controller 165 determines whether or not the block matching about all target blocks in the target frame has been ended (step S11). If it is determined that the processing of the block matching has not been ended about all target blocks, the processing returns to the step S4 and the next target block in the target frame is set, so that the processing of the steps S4 to S11 is repeated.

If the controller 165 determines in the step S11 that the block matching about all target blocks in the target frame has been ended, the processing moves to a step S12. In the step S12, it is determined whether or not the processing about all reference frames that should be superimposed on each other has been ended, i.e. whether or not N is equal to M.

If it is determined in the step S12 that N is not equal to M, N is incremented by 1 (N=N+1) (step S13). Next, the NR image generated by the superposition in the step S10 is set as the target image (target frame) and the image of N=N+1 is set as the reference image (reference frame) (step S14). Thereafter, the processing returns to the step S4 and the processing of this step S4 and the subsequent steps is repeated. That is, if M is equal to or larger than three, the above-described processing is repeated in such a manner that the image resulting from the superposition about all target blocks is set as the next target image and the third or subsequent image is set as the reference frame. This is repeated until the end of the superposition of the M-th image. If it is determined in the step S12 that N is equal to M, this processing routine is ended.

### <Moving Image Photographing>

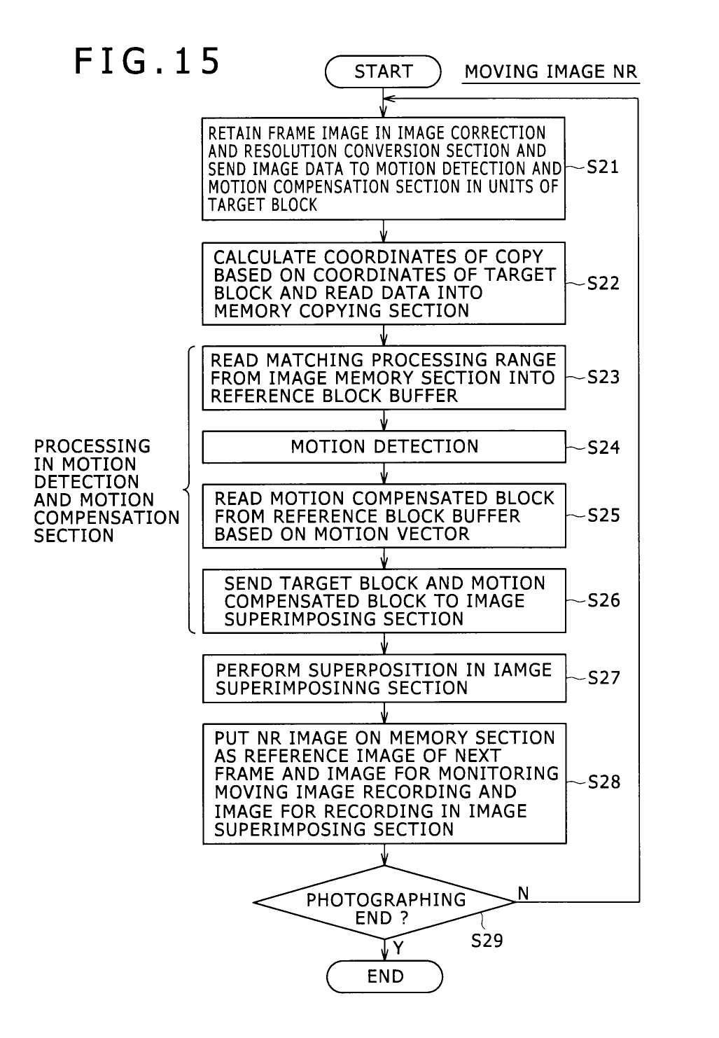

FIG. 15 shows a flowchart of the noise reduction processing by image superposition in moving image photographing in the imaging device of this embodiment. The respective steps in the flowchart of FIG. 15 are also carried out under control by the CPU 1 and the controller 165 of the motion detection and motion compensation section 16 controlled by this CPU 1. When the moving image recording button is operated by the user, the CPU 1 orders initiation of the processing of FIG. 15 from the start.

In this example, the motion detection and motion compensation section 16 has a configuration suitable for executing matching processing in units of the target block. So, in accordance with control by the CPU 1, the image correction and resolution conversion section 15 retains a frame image and sends the image data to the motion detection and motion compensation section 16 in units of the target block (step S21).

The image data of the target block sent to the motion detection and motion compensation section 16 are stored in the target block buffer 161. Next, the controller 165 calculates the coordinates of copy as a reference block from the image memory 40 based on the coordinates of the target block, and reads out the data of the calculated coordinates from the image memory 40 into the automatic memory copying section 50 (step S22). The read data are written to the secondary memory 60 and then the data of the desired area are supplied to the reference block buffer 162, which is the primary memory (step S23).

Next, the matching processing section 163 and the motion vector calculator 164 execute motion detection processing by hierarchical block matching in this example (step S24). Specifically, the matching processing section 163 first calculates the SAD value between the pixel values of the reduced-plane target block and the pixel values of the reduced-plane reference block in the reduced plane and sends the calculated SAD value to the motion vector calculator 164. The matching processing section 163 repeats this processing about all reduced-plane reference blocks in the search range. After the end of the calculation of the SAD values about all reduced-plane reference blocks in the search range, the motion vector calculator 164 specifies the minimum SAD value to detect the reduced-plane motion vector.

The controller 165 multiplies the reduced-plane motion vector detected by the motion vector calculator 164 by the inversion of the reduction rate to convert it to a motion vector on the base plane. Then, the controller 165 regards the area whose center is the position indicated by the converted vector in the base plane as the search range in the base plane. Then, the controller 165 carries out control to make the matching processing section 163 execute block matching processing in the base plane in this search range. The matching processing section 163 calculates the SAD value between the pixel values of the base-plane target block and the pixel values of the base-plane reference block and sends the calculated SAD value to the motion vector calculator 164.

After the end of the calculation of the SAD values about all base-plane reference blocks in the search range, the motion vector calculator 164 specifies the minimum SAD value to detect the base-plane motion vector and specifies the SAD value near the minimum SAD value. Then, the motion vector calculator 164 executes quadratic curve approximate interpolation processing by using these SAD values and outputs a high-accuracy motion vector of sub-pixel accuracy.

Next, the controller 165 reads out the image data of a motion compensated block from the reference block buffer 162 in accordance with the high-accuracy motion vector calculated in the step S24 (step S25). Then, the controller 165 sends this image data to the image superimposing section 17 at the subsequent stage in synchronization with the target block (step S26).

The image superimposing section 17 performs superposition of the target block and the motion compensated block and makes the image data of the NR image as the result of the superposition be output to the side of the image memory 40 and written thereto (step S27). Then, the image data of the NR image are stored in the image memory 40 as the reference frame for the next target frame (step S28).

Then, the CPU 1 determines whether or not operation of stopping moving image recording is carried out by the user (step S29). If the CPU 1 determines that the operation of stopping moving image recording is not carried out by the user, the CPU 1 orders return to the step S21 and repetition of the processing of this step S21 and the subsequent steps. If the CPU 1 determines in the step S29 that the operation of stopping moving image recording is carried out by the user, the CPU 1 ends this processing routine.

In the processing routine of the above-described noise reduction processing for the moving image, the image frame that is previous by one frame is set as the reference frame. However, the image of a frame that is previous by two or more frames may be used as the reference frame. Alternatively, it is also possible to store the images of the frames that are previous by one frame and by two frames in the image memory 40 and select which image frame is used as the reference frame depending on the content of these two pieces of image information.

By using the above-described measures, procedures, and system configurations, the still-image noise reduction processing and the moving-image noise reduction processing can be executed by hardware for one common kind of block matching processing.

### [5. Example of Flow of Hierarchical Block Matching Processing]

FIG. 16 and FIG. 17 show flowcharts of an operation example of the hierarchical block matching processing in the motion detection and motion compensation section 16.

The flow of the processing shown in FIG. 16 and FIG. 17 partially overlaps with the explanation of the flow of the above-described processing example of the matching processing section 163 and the motion vector calculator 164. However, this flow will be described in order to facilitate understanding of the operation of this example.

First, in the motion detection and motion compensation section 16, a reduced image of a target block, i.e. a reduced-plane target block, is read from the target block buffer 161 (step S71 in FIG. 16). Next, the initial value of the reduced-plane minimum SAD value is set as the initial value of a minimum SAD value Smin retained in the motion vector calculator 164 (step S72). As the initial value of this reduced-plane minimum SAD value Smin, e.g. the maximum value of the pixel difference is set.

Next, the matching processing section 163 sets the reduced-plane search range. The matching processing section 163 sets the reduced-plane reference vector (Vx/n, Vy/n: 1/n is the reduction rate) in the set reduced-plane search range and sets the position of the reduced-plane reference block about which the SAD value is calculated (step S73). Then, the matching processing section 163 reads the pixel data of the set reduced-plane reference block from the reference block buffer 162 (step S74), and obtains the total sum of the absolute values of the differences in the respective pixel data between the reduced-plane target block and the reduced-plane reference block, i.e. the reduced-plane SAD value. The obtained reduced-plane SAD value is sent out to the motion vector calculator 164 (step S75).

The motion vector calculator 164 compares the reduced-plane SAD value Sin calculated in the matching processing section 163 with the retained reduced-plane minimum SAD value Smin. Then, the motion vector calculator 164 determines whether or not the calculated reduced-plane SAD value Sin is smaller than the reduced-plane minimum SAD value Smin retained thus far (step S76).

If it is determined in this step S76 that the calculated reduced-plane SAD value Sin is smaller than the reduced-plane minimum SAD value Smin, the processing proceeds to a step S77 and the retained reduced-plane minimum SAD value Smin and position information thereof are updated.

Specifically, in the SAD value comparison processing, information of the comparison result indicating that the calculated reduced-plane SAD value Sin is smaller than the reduced-plane minimum SAD value Smin is output. Then, this calculated reduced-plane SAD value Sin and position information thereof (reduced-plane reference vector) are retained as information of the new reduced-plane minimum SAD value Smin.

After the step S77, the processing proceeds to a step S78. If it is determined in the step S76 that the calculated reduced-plane SAD value Sin is larger than the reduced-plane minimum SAD value Smin, the processing proceeds to the step S78 without executing the processing of updating the retained information in the step S77.

In the step S78, the matching processing section 163 determines whether or not the matching processing has been ended at the positions of all reduced-plane reference blocks (reduced-plane reference vectors) in the reduced-plane search range. If it is determined that the reduced-plane reference block that has not yet been processed exists in the reduced-plane search range, the processing returns to the step S73 and the above-described processing of the step S73 and the subsequent steps is repeated.

If the matching processing section 163 determines in the step S78 that the matching processing has been ended at the positions of all reduced-plane reference blocks (reduced-plane reference vectors) in the reduced-plane search range, the matching processing section 163 executes the following processing. Specifically, the matching processing section 163 receives position information (reduced-plane motion vector) of the reduced-plane minimum SAD value Smin. Then, the matching processing section 163 sets a base-plane target block at the position whose center is the position coordinates indicated in the base-plane target frame by the vector obtained by multiplying the received reduced-plane motion vector by the inversion of the reduction rate, i.e. by n. Furthermore, the matching processing section 163 sets a base-plane search range in the base-plane target frame as a comparatively-small range whose center is the position coordinates indicated by the vector obtained by the multiplication by n (step S79). Then, the matching processing section 163 reads the pixel data of the base-plane target block from the target block buffer 161 (step S80).

Next, the initial value of the base-plane minimum SAD value is set as the initial value of the minimum SAD value Smin retained in the motion vector calculator 164 (step S81 in FIG. 17). As the initial value of this base-plane minimum SAD value Smin, e.g. the maximum value of the pixel difference is set.

Next, the matching processing section 163 sets a base-plane reference vector (Vx, Vy) and the position of a base-plane reference block about which the SAD value is calculated in the base-plane search range set in the step S79 (step S82). Then, the matching processing section 163 reads the pixel data of the set base-plane reference block from the reference block buffer 162 (step S83). Subsequently, the matching processing section 163 obtains the total sum of the absolute values of the differences in the respective pixel data between the base-plane target block and the base-plane reference block, i.e. the base-plane SAD value, and sends out the obtained base-plane SAD value to the motion vector calculator 164 (step S84).

The motion vector calculator 164 compares the base-plane SAD value Sin calculated in the matching processing section 163 with the retained base-plane minimum SAD value Smin. By this comparison, the motion vector calculator 164 determines whether or not the calculated base-plane SAD value Sin is smaller than the base-plane minimum SAD value Smin retained thus far (step S85).

If it is determined in this step S85 that the calculated base-plane SAD value Sin is smaller than the base-plane minimum SAD value Smin, the processing proceeds to a step S86 and the retained base-plane minimum SAD value Smin and position information thereof are updated.

Specifically, information of the comparison result indicating that the calculated base-plane SAD value Sin is smaller than the base-plane minimum SAD value Smin is output. Then, this calculated base-plane SAD value Sin and position information thereof (reference vector) are employed as information of the new base-plane minimum SAD value Smin and update to the new base-plane SAD value Sin and position information thereof is performed.

After the step S86, the processing proceeds to a step S87. If it is determined in the step S85 that the calculated base-plane SAD value Sin is larger than the base-plane minimum SAD value Smin, the processing proceeds to the step S87 without executing the processing of updating the retained information in the step S86.

In the step S87, the matching processing section 163 determines whether or not the matching processing has been ended at the positions of all base-plane reference blocks (base-plane reference vectors) in the base-plane search range. If it is determined that the base-plane reference block that has not yet been processed exists in the base-plane search range, the processing returns to the step S82 and the above-described processing of the step S82 and the subsequent steps is repeated.

If the matching processing section 163 determines in the step S87 that the matching processing has been ended at the positions of all base-plane reference blocks (base-plane reference vectors) in the base-plane search range, the matching processing section 163 executes the following processing. Specifically, the matching processing section 163 receives position information (base-plane motion vector) of the base-plane minimum SAD value Smin and makes the base-plane SAD value be retained (step S88).

This is the end of the block matching processing of this example about one reference frame.

### [6. Description of Format on Memory]

In the example of the present embodiment, the image data of one frame are divided as shown in FIG. 18A. Specifically, the horizontal direction of the image of one screen is divided in units of one burst transfer (64 pixels) and the image of one screen is treated as plural data in units of the image of the vertically-long divided block (hereinafter, referred to as the strip). Furthermore, a memory access system in which the image data are written to and read from the image memory 40 in units of this strip (hereinafter, referred to as the strip access form) is employed. In still-image NR processing, basically memory access of image data to the image memory 40 is performed by this strip access form.

The format in which bus access for 64 pixels along the horizontal direction is performed in 16 bursts will be referred to as the 64×1 format. This 64×1 format is a memory access system in which, as shown in FIG. 18B, burst transfer in units of four pixels is consecutively repeated 16 times, which is the maximum number of times of consecutive bursts. As shown in FIG. 18B, if the beginning addresses A1, A2, A3, . . . A16 of the burst transfer in units of four pixels are defined, the bus access of the 64×1 format can be automatically performed.

The strip access form is a system in which the 64×1 format is consecutively carried out in the vertical direction of the screen. The 64×1 format is repeated in the horizontal direction. After the end of all access for one line, similar access is performed for the next line. This allows image data access of a raster scan form.

If the image data of the horizontal direction are indivisible by 64 pixels, as shown by a shadow area in FIGS. 18A and 18B, a dummy area 151 is provided at the right end of the horizontal direction and e.g. pixel data of black or white are added as dummy data in this dummy area 151. In this manner, the number of pixels along the horizontal direction is set to a multiple of 64.

The existing raster scan system is suitable for reading data on each one line basis because the address is consecutive in the horizontal direction regarding access to the image memory. In contrast, the strip access form is suitable for reading block-like data in which the number of pixels along the horizontal direction is equal to or smaller than 64 because the address is incremented in the vertical direction in units of one burst transfer (64 pixels).

For example, suppose that, in reading of a block of a strip form of 64 pixels×64 lines, the memory controller 8 performs bus access to the image memory section 4 for four-pixel data of YC pixel data (64 bits) in 16 bursts. In this case, these 16 bursts correspond to data of 4×16=64 pixels. Thus, subsequent to setting of the address of the first line composed of 64 pixels along the horizontal direction, the addresses of the pixel data of the remaining 63 lines can be set through address increment in the vertical direction.

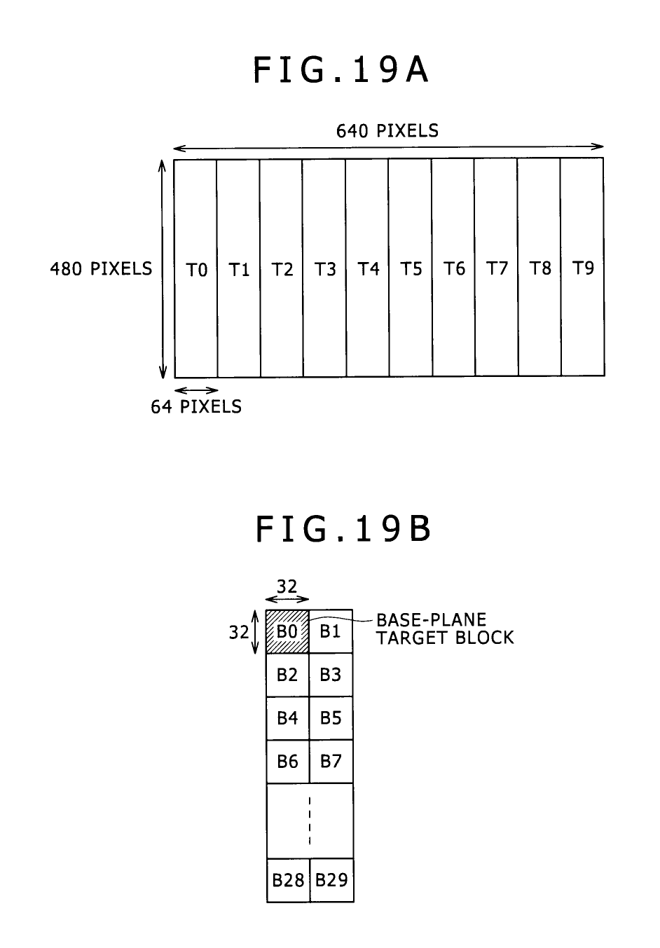

FIG. 19A shows a division example of the strip unit in an example in which the image of one screen is composed of horizontal×vertical=640×480 pixels. In this example, the image of one screen is divided in units of 64 pixels along the horizontal direction and consequently is separated into 10 strips T0 to T9.

When a base-plane target block is read from the image memory 40 in still-image NR processing, access is performed in units of 64 pixels×1 line to enhance the bus efficiency in this example in order to utilize the advantages of the strip access form.

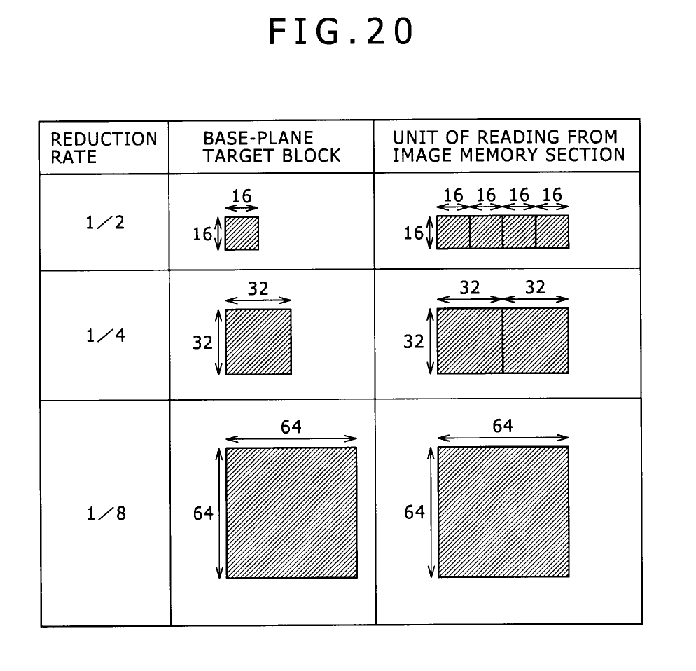

For example, as shown in FIG. 20, when the reduction rate of the reduced plane with respect to the base plane is ½, the size of the base-plane target block is horizontal×vertical=16 pixels×16 lines in this embodiment. Therefore, the number of pixels along the horizontal direction becomes 64 pixels when four base-plane target blocks are arranged along the horizontal direction. So, in this example, when the reduction rate is ½, the unit of access to the image memory 40 is set to four target blocks as shown on the right side of FIG. 20 and access is performed by the strip access form of the above-described 64×1 format. That is, four target blocks can be transferred by repeating access in units of 64 pixels along the horizontal direction (4 pixels×16 bursts) 16 times with address changes in the vertical direction.

Similarly, as shown in FIG. 20, when the reduction rate of the reduced plane with respect to the base plane is ¼, the size of the base-plane target block is horizontal×vertical=32 pixels×32 lines in this example. Thus, access to the image memory is performed in units of two base-plane target blocks. This allows access by the strip access form of the above-described 64×1 format. When the reduction rate of the reduced plane with respect to the base plane is ⅛, the size of the base-plane target block is horizontal×vertical=64 pixels×64 lines in this example. Thus, access to the image memory is performed in units of one base-plane target block. This allows access by the strip access form of the above-described 64×1 format.

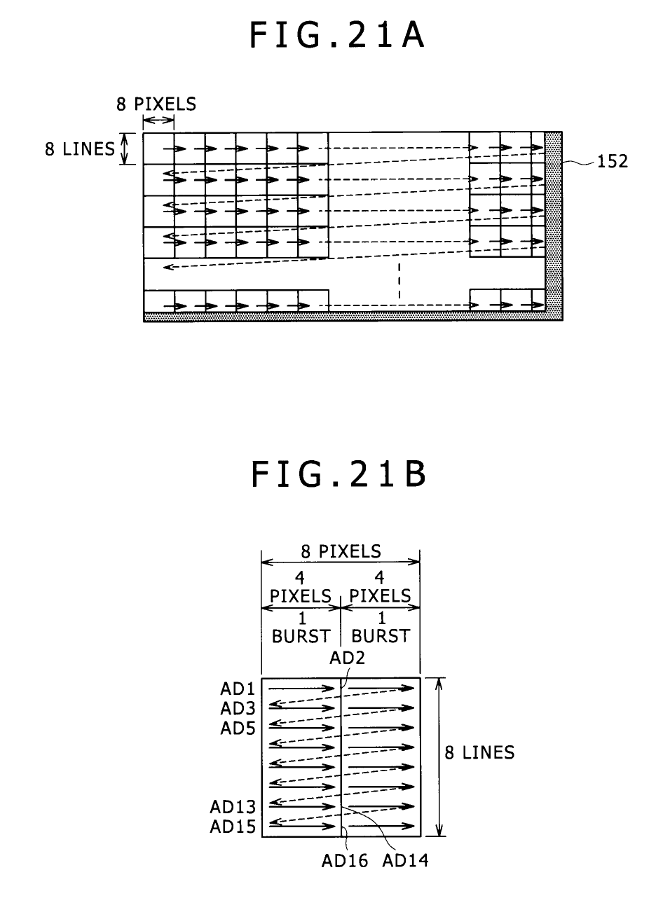

Examples of the data format in memory access in moving-image NR processing will be described below with reference to FIGS. 21A to 30.

In these examples, a memory access system (block access form) of pixel data in units of a block of a rectangular area composed of plural lines×plural pixels is prepared for reference-image access to the memory of image data for reference in the moving-image NR processing.

Specifically, as one of forms for reference-image access in the moving-image NR processing, a form shown in FIG. 21A is prepared in consideration of 64 pixels, which is the maximum number of pixels that can be transferred by the above-described burst transfer. More specifically, a block access form in which the image (screen) is divided into blocks of horizontal×vertical=8 pixels×8 lines, which are the maximum unit of burst transfer (64 pixels), and writing/reading to/from the image memory section 4 is performed is used. Hereinafter, this block access form in units of the block of 8 lines×8 pixels will be referred to as the 8×8 format.

In this 8×8 format, as shown in FIG. 21B, four pixels along the horizontal direction are treated as the unit of one burst transfer and eight pixels along the horizontal direction are transferred by two times of burst transistor (two bursts). After the end of the burst transfer of these eight pixels along the horizontal direction, eight pixels on the next line are transferred in two bursts similarly. In 16 bursts, which is the maximum burst length, 64 pixels are transferred in one time.

If a beginning address AD1 in the block access form of this 8×8 format is defined as the initial address, as shown in FIG. 21B, addresses AD2 to AD16 in units of four pixels are automatically defined and memory access in the 8×8 format can be performed by consecutive 16bursts.

When the beginning address AD1 in the 8×8 format is specified on the image memory 40, the memory controller calculates the addresses AD1 to AD16 for memory access in the 8×8 format and executes the memory access in the 8×8 format.

The 8×8 format basically leads to access in units of 64 pixels (16 bursts) as shown in FIG. 21B and thus is the most efficient. However, as described later, 16 bursts are the maximum burst length and a shorter burst length can also be employed. In this case, the form is not the 8×8 format substantially. However, for example in the case of 8 pixels×4 lines, image data can be transferred in eight bursts, which are half of 16 bursts.

If the image data of the horizontal direction and the vertical direction are indivisible by eight pixels, as shown by a shadow area in FIGS. 21A and 21B, a dummy area 152 is provided at the right end of the horizontal direction and the lower end of the vertical direction and e.g. pixel data of black or white are added as dummy data in this dummy area 152. Accordingly, the image sizes in the horizontal direction and the vertical direction are each set to a multiple of eight.

That the access can be performed in units of 8×8 pixels by memory access in the 8×8 format means that all of reduced-plane matching processing range and base-plane matching processing range can be read from the image memory section 4 in units of the 8×8 pixel block. Therefore, in the imaging device of this embodiment, bus access only by the most efficient data transfer (16 bursts) is enabled and thus the bus efficiency is maximized.

If this 8×8 format is modified to a format based on a multiple of 8×8 pixels, such as 16×16 pixels or 16×8 pixels, the modified format can be applied to access in units of these plural pixels.

Although the most efficient data transfer unit of the bus (unit of the maximum burst length) is 64 pixels in the above-described example, the most efficient data transfer unit is p×q pixels determined by the number p of pixels that can be transferred by one burst and the maximum burst length (the maximum number of times of consecutive bursts) q. Based on the number of pixels (p×q), the format of the block access form of writing to the image memory 40 is decided. The bus transfer efficiency is the highest when the reduced-plane matching processing range and the base-plane matching processing range have sizes close to multiples of the numbers of pixels along the horizontal direction and the vertical direction of the block format.

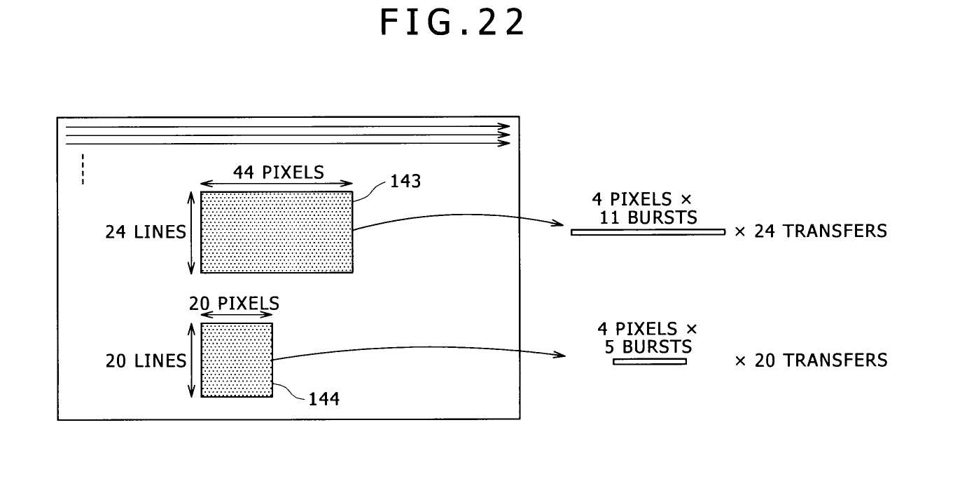

As shown in FIG. 22, the reduced-plane matching processing range 143 is 44 pixels×24 lines in this example. If this reduced-plane matching processing range 143 is accessed in the 64×1 format, access with transfer in which transfer of 4 pixels×11 bursts is repeated 24 times in the vertical direction should be performed as shown on the upper side of FIG. 22.

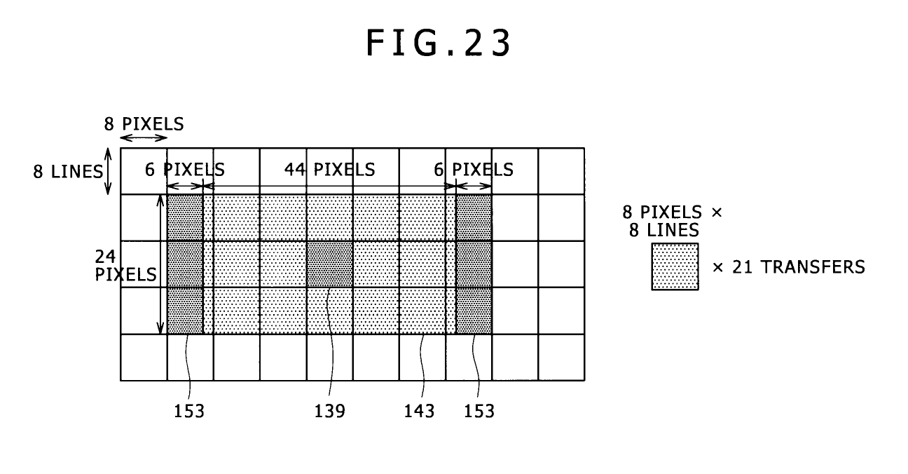

In contrast, if the same reduced-plane matching processing range 143 is accessed in the 8×8 format, as shown in FIG. 23, the reduced-plane matching processing range 143 of 44 pixels×24 lines is decided in such a manner that the reduced-plane reference block of a reduced-plane reference vector (0, 0) is the center. The reduced-plane reference block of the reduced-plane reference vector (0, 0) refers to the reduced-plane reference block at the same coordinates as those of the reduced-plane target block. In this case, the reduced-plane target block is set only in units of eight pixels and in units of eight lines.

The number of lines of the reduced-plane matching processing range 143 in the vertical direction is 24. Therefore, if the size of the search range in the vertical direction is set to a multiple of the 8×8 block size, access can be performed by the 8×8 format without uselessness regarding the vertical direction. On the other hand, the number of pixels of the reduced-plane matching processing range 143 along the horizontal direction is 44 and therefore is not a multiple of eight. Accordingly, in the example shown in FIG. 23, the number of pixels along the horizontal direction is set to 56 and six pixels of dummy image data 153 of e.g. black or white are inserted on each of both sides of the horizontal direction in the 8×8 format.

From FIG. 23, it is understood that, although six pixels of the dummy image data 153 exist on each of the left and right ends, the data can be read by 21 times of transfer in the 8×8 format in contrast to the 64×1 format, which needs 24 times of transfer. Furthermore, in the 8×8 format, all transfer is the most efficient data transfer (16 bursts) in the imaging device of this embodiment and the bus efficiency is also enhanced.

The base-plane matching processing range 144 when the reduction rate is ½ is 20 pixels×20 lines. When this base-plane matching processing range 144 is accessed, in the case of the 64×1 format, access with transfer in which transfer of 4 pixels×5bursts is repeated 20 times in the vertical direction should be performed as shown on the lower side of FIG. 22.

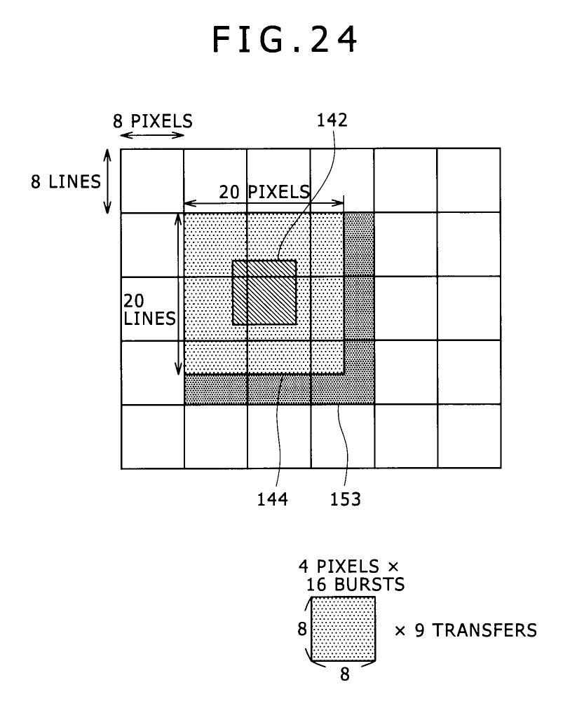

In contrast, in the case of the 8×8 format, a matching processing range of 20 pixels×20 lines is decided as the base-plane matching processing range 144 in such a manner that the base-plane reference block 142 of a base-plane reference vector (0, 0) is the center as shown in FIG. 24. The base-plane matching processing range 144 is determined by the reduced-plane motion vector calculated by reduced-plane matching and therefore various combinations will be possible in units of one pixel.

For example, the most efficient case is when the base-plane matching processing range 144 of 20 pixels×20 lines is allocated to nine blocks of 8×8 pixels as shown in FIG. 24. In this case, as shown in FIG. 24, areas smaller than eight pixels and eight lines exist at an end part in the horizontal direction and an end part in the vertical direction in the base-plane matching processing range 144 of 20 pixels×20 lines. Therefore, the dummy pixel data 153 are inserted in these areas and access with transfer in which transfer of 4 pixel×16 bursts in the 8×8 format is repeated nine times is performed. This allows access to the image data of the base-plane matching processing range 144 of 20 pixels×20 lines.

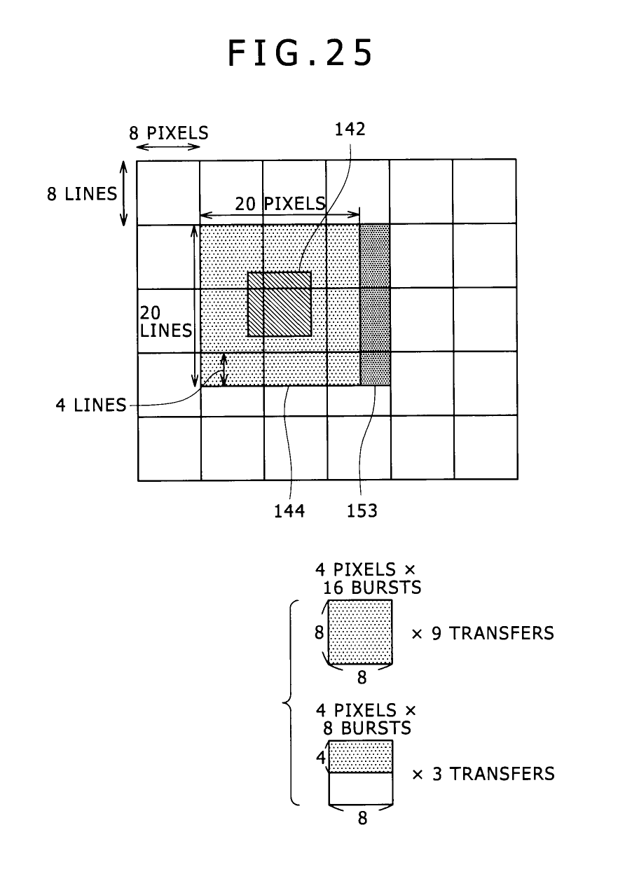

However, as shown in FIG. 25, the following way of access with transfer can also be employed. Specifically, the dummy image data 153 are not inserted at the end part in the vertical direction in the base-plane matching processing range 144 of 20 pixels×20 lines. For this end part in the vertical direction, the number of times of burst is suited to the data that should be transferred (for four lines) and transfer of 4 pixels×8 bursts is repeated three times. In this case, in the example shown in FIG. 25, access to the image data of the base-plane matching processing range 144 of 20 pixels×20 lines can be performed by total nine times of transfer, i.e. six times of repetition of transfer of 4 pixels×16 bursts in the 8×8 format and three times of repetition of transfer of 4 pixels×8 bursts.

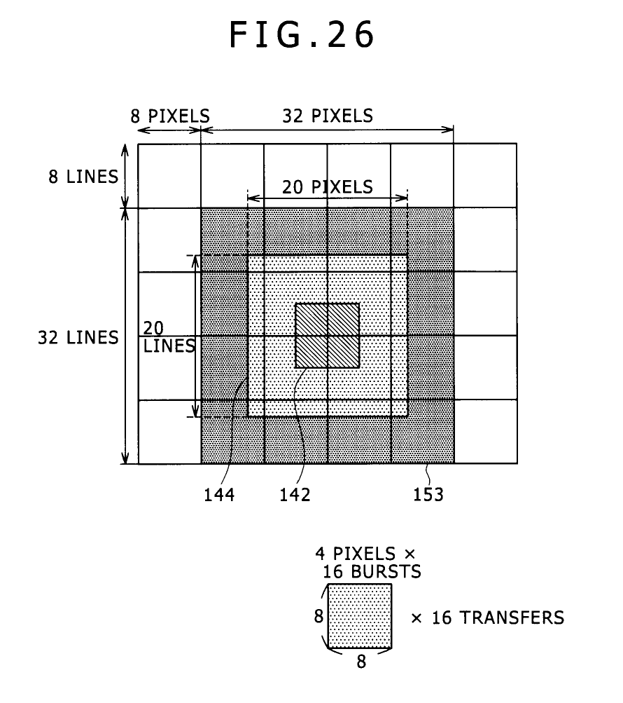

Conversely, an example of the lowest efficiency is the case in which the base-plane matching processing range 144 of 20 pixels×20 lines ranges over 16 blocks of 8×8 pixels as shown in FIG. 26. In this case, as shown in FIG. 26, areas smaller than eight pixels and eight lines exist at end parts in the horizontal direction and end parts in the vertical direction in the base-plane matching processing range 144 of 20 pixels×20 lines. The dummy pixel data 153 are inserted in these areas and access with transfer in which transfer of 4 pixels×16 bursts in the 8×8 format is repeated 16 times is performed. This allows access to the image data of the base-plane matching processing range 144 of 20 pixels×20 lines.

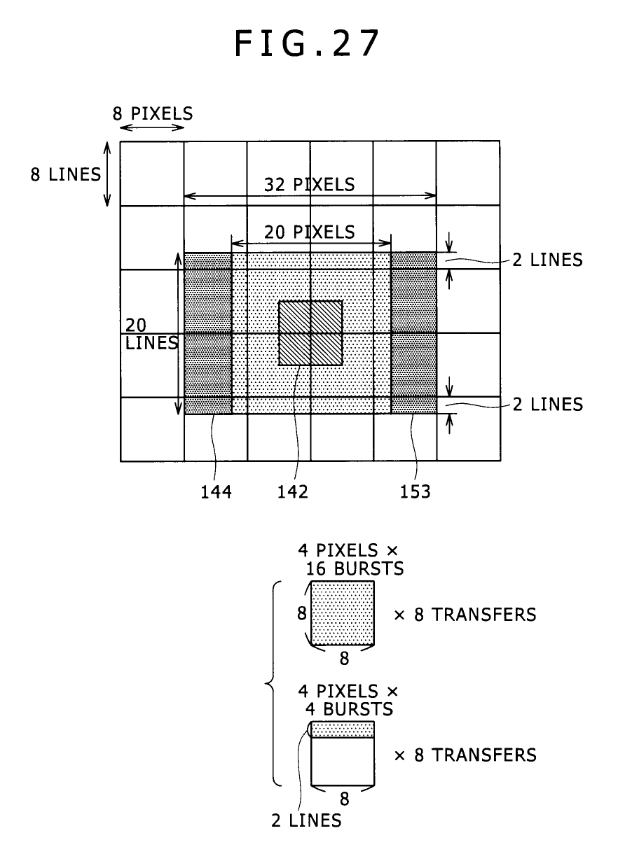

However, as shown in FIG. 27, the following way is also possible. Specifically, the dummy image data 153 are not inserted at the end parts in the vertical direction in the base-plane matching processing range 144 of 20 pixels×20 lines. For these upper and lower end parts in the vertical direction, the number of times of burst is suited to the data that should be transferred (for two lines at each end part). That is, it is also possible to employ access with transfer in which transfer of 4 pixels×4 bursts is repeated eight times in total. In this case, in the example shown in FIG. 27, access to the image data of the base-plane matching processing range 144 can be performed by total 16 times of transfer, i.e. eight times of repetition of transfer of 4 pixels×16 bursts in the 8×8 format and eight times of repetition of transfer of 4 pixels×4 bursts.

Therefore, in the access to the image memory 40 for the image data of the base-plane matching processing range 144 of 20 pixels×20 lines, 20 times of transfer are necessary in the 64×1 format. In contrast, in the 8×8 format, at least nine times of transfer and at most 16 times of transfer are enough. Moreover, in the 8×8 format, half or more of the transfer is the most efficient data transfer (16 bursts) in the imaging device system of this example.

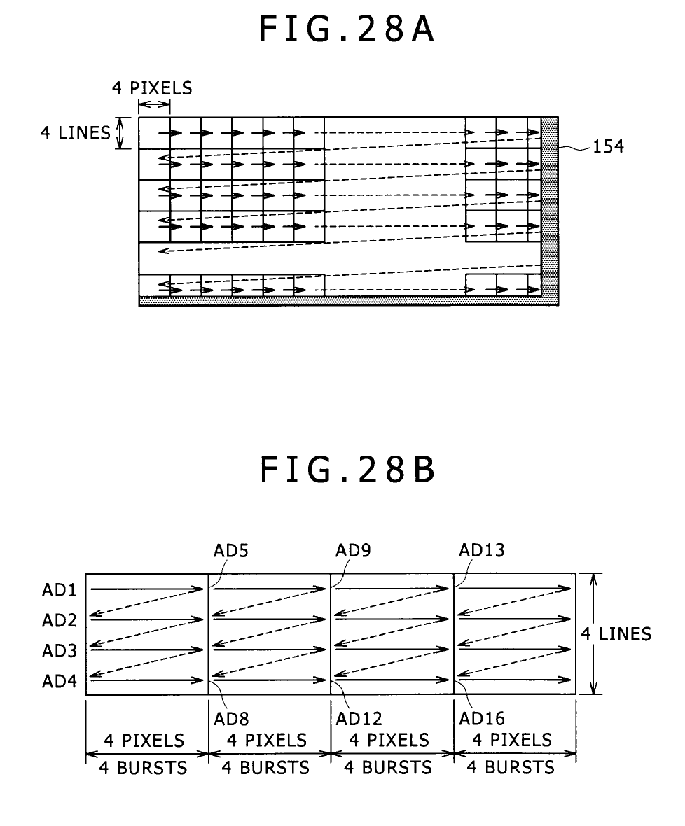

Furthermore, this embodiment is so configured that it is also possible to select a block access form in which the image (screen) is divided into blocks of 4pixels×4 lines, which are the ¼ unit of the maximum burst transfer (64 pixels), and writing/reading to/from the image memory section is performed as shown in FIG. 28A as another form for reference-image access in the moving-image NR processing. Hereinafter, this block access form in units of the block composed of 4 lines×4 pixels will be referred to as the 4×4 format.

In this 4×4 format, as shown in FIG. 28B, four pixels along the horizontal direction are treated as the unit of one burst transfer and four pixels along the horizontal direction are transferred by one time of burst transfer (one burst). After the end of the burst transfer of these four pixels along the horizontal direction, four pixels on the next line are transferred. That is, four pixels on the next line are transferred in one burst similarly and image data of the 4×4 format can be transferred in four bursts. In the case of the 4×4 format, as shown in FIG. 28B, data of 64 pixels are transferred in one time by accessing the blocks composed of 4 pixels×4 lines=16 pixels four times consecutively in the horizontal direction (four blocks).

That is, image data of the 4×4 format can be transferred in four bursts. Four blocks of 4 pixels×4 lines along the horizontal direction can be consecutively accessed in 16 bursts, which are the maximum burst length, and data of 64 pixels of these four blocks of 4 pixels×4 lines are transferred in one time.

In the case of transferring data of 64 pixels (16 bursts as the maximum burst length) in one time by this 4×4 format, a beginning address AD1 of the block of 4 pixels×4 lines is defined as the initial address as shown in FIG. 28B. At this time, addresses AD2 to AD16 in units of four pixels are defined as shown in the diagram and memory access in units of 64 pixels by the 4×4 format can be performed in consecutive 16 bursts.

The efficiency of the 4×4 format is the highest when access is performed in units of 64 pixels (16 bursts) as shown in FIG. 28B. However, there is also the case in which access should be performed in units of four or less blocks along the horizontal direction. For example, in access in units of two blocks (32 pixels) along the horizontal direction, the addresses AD1 to AD8 in units of four pixels are defined in FIG. 28B and access in units of 32 pixels can be performed in consecutive eight bursts. Access can be similarly performed also in units of one block (16 pixels) of 4 pixels×4 lines and in units of three blocks (48 pixels).

When the beginning address AD1 of the 4×4 format and the number of blocks of 4 pixels×4 lines along the horizontal direction are specified on the frame memory of the image memory 40, the memory controller calculates the address AD2 and the subsequent addresses for memory access in the 4×4 format and accesses the memory 40.

Similarly to the case of the above-described 8×8 format, if image data are indivisible by four pixels, a dummy area 154 is provided at the right end of the horizontal direction and the lower end of the vertical direction as shown in FIG. 28A to set the sizes in the horizontal direction and the vertical direction to multiples of four.

This 4×4 format further improves the above-described bus access to the base-plane matching processing range (20 pixels×20 lines) 144 compared with the 8×8 format.

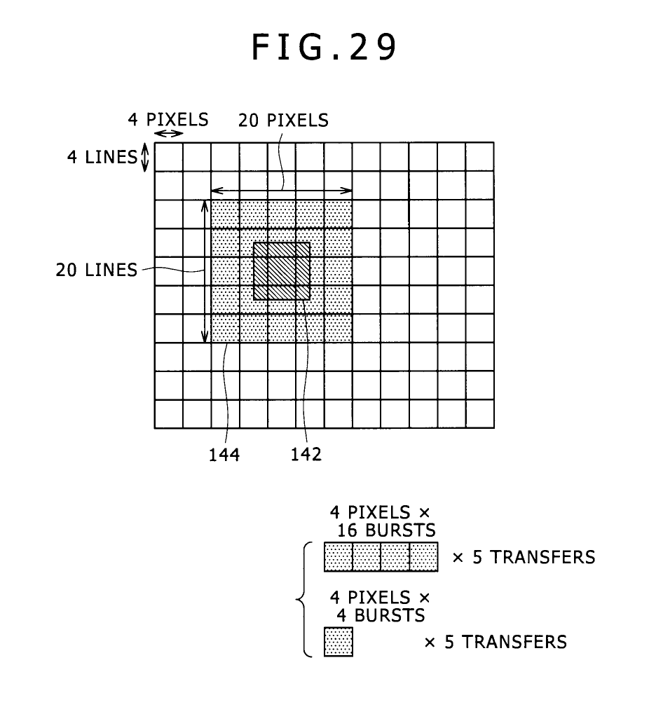

The most efficient case with the block unit of 4 pixels×4 lines is when the base-plane matching processing range 144 of 20 pixels×20 lines is allocated to just 5 blocks along the horizontal direction×5 blocks along the vertical direction=25 blocks as shown in FIG. 29.

For access to these 25 blocks, the blocks can be divided into five lines of four blocks along the horizontal direction and five lines of one block along the horizontal direction. The access can be performed by total ten times of transfer, i.e. five times of transfer of 4 pixels×16 bursts in units of four blocks based on the maximum burst length of FIG. 28B and five times of transfer of 4 pixels×4 bursts in units of one block.

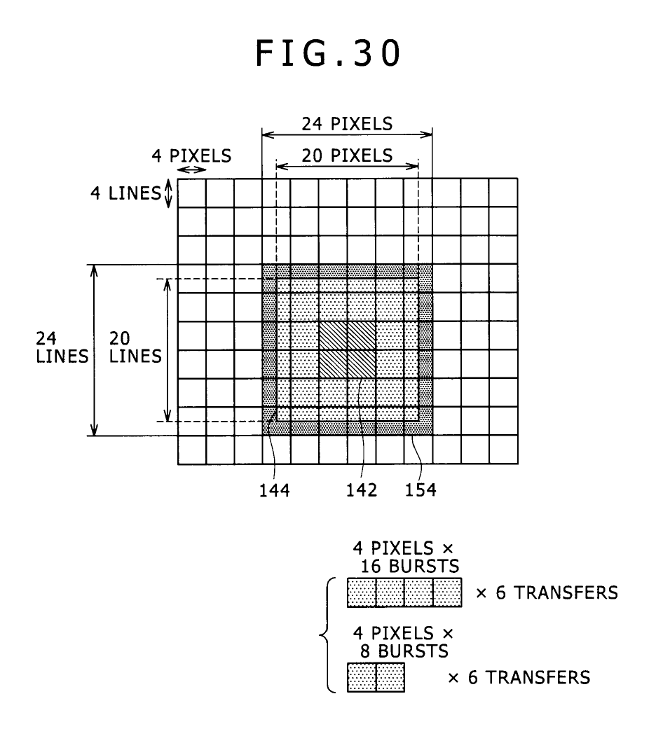

Conversely, an example of the lowest efficiency is the case in which the base-plane matching processing range 144 of 20 pixels×20 lines ranges over 6 blocks along the horizontal direction×6 blocks along the vertical direction=36 blocks of 4 pixels×4 lines as shown in FIG. 30. In this case, as shown in FIG. 30, areas smaller than four pixels and four lines exist at the left and right end parts in the horizontal direction and the upper and lower end parts in the vertical direction in the base-plane matching processing range 144 of 20 pixels×20 lines. Therefore, the dummy pixel data 154 are inserted in these areas.

For access to these 36 blocks in the 4×4 format, the blocks can be divided into six lines of four blocks along the horizontal direction and six lines of two blocks along the horizontal direction. The access can be performed by total 12 times of transfer, i.e. six times of transfer of 4 pixels×16 bursts in units of four blocks based on the maximum burst length of FIG. 28B and six times of transfer of 4 pixels×8 bursts in units of two blocks.

Therefore, the number of times of transfer access is smaller than 16 times of transfer in the case of the 8×8 format shown in FIG. 27. Furthermore, the ratio of use of 16-burst transfer, which is the most efficient data transfer in the imaging device of this embodiment, increases, and the bus efficiency is further enhanced.

[7. Description of Processing with Use of Secondary Memory]

In the example of the present embodiment, data resulting from format conversion of data stored in the image memory 40 by the automatic memory copying section 50 are read out to the secondary memory 60 as shown in FIG. 1 and FIG. 2. Then, data are written from the secondary memory 60 to the primary memory.

In the present embodiment, a buffer (secondary memory 60) with rotation in the vertical direction is prepared outside the base-plane reference buffer (internal primary memory) as shown in FIG. 2. In recent years, development of the built-in SRAM of the system LSI is being promoted and data that yield a heavy band load when being put on an external image memory can be managed in the memory configured as the built-in SRAM. The secondary memory 60 as a built-in buffer of the present embodiment is configured by such an SRAM embedded in the motion detection and motion compensation section 16 for example.

In general, in the image memory such as a DRAM, the data efficiency is lowered due to bank management of the controller and refresh operation and therefore random access such as access to a reference block tends to consume a wider bus band. In contrast, the built-in SRAM is free from factors in the lowering of the data efficiency, such as bank management and refresh, and thus has an advantage of being not bad at random access.

As described in data write processing to be described later, data are copied from the image memory 40 configured by a DRAM to the internal secondary memory 60 in such a manner that consecutive data are copied in burst transfer so that the occurrence of random access may be prevented. Therefore, the efficiency lowering is small in data access on the image memory 40. On the other hand, the motion detection and motion compensation section 16, which is an image processor, performs random access to the internal secondary memory 60. However, because it is a built-in SRAM, the efficiency lowering like that observed in access to a DRAM is absent.

With reference to flowcharts of FIG. 31 and FIG. 32, processing of reading and writing data of the first frame (FIG. 31) and processing of reading and writing data of the second or subsequent frame (FIG. 32), executed under control by the automatic memory copying section 50, are described.

As the processing for the first frame in FIG. 31, the end of main line processing is awaited (step S101) and copy processing of reading the area used in motion detection of the beginning block of the next frame from the image memory 40 and writing it to the secondary memory 60 is executed (step S102).

As the processing for the second or subsequent frame in FIG. 32, the start of motion detection for one target block is awaited (step S111), and an area corresponding to the one target block is copied (step S112).

Then, whether or not the copy processing for one frame has been ended is determined (step S113). If the copy has not been ended, the processing returns to the step S111 and the copy processing is continued. If it is determined in the step S113 that the copy processing for one frame has been ended, the copy processing of this frame is ended.

In this manner, data are transferred to the internal secondary memory 60 in units of the data of one reference frame and the data in a matching processing range of the reference frame are transferred from the internal secondary memory 60 to the buffer 16a as the internal primary memory and retained therein. The buffer 16a as the internal primary memory is equivalent to the reference block buffer 162 shown in FIG. 9.

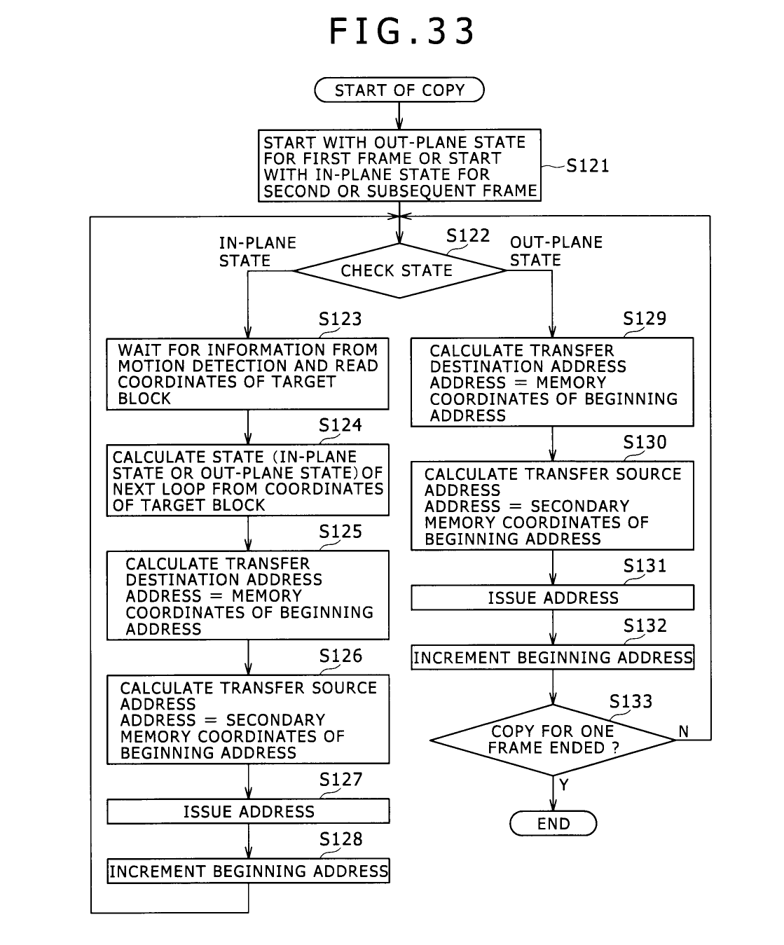

FIG. 33 is a diagram showing, in more detail, the copy processing of FIG. 31 and FIG. 32, executed by the automatic memory copying section 50 shown in FIG. 2.

First, the processing is started with the out-plane state for the first frame or with the in-plane state for the second or subsequent frame (step S121).

Then, the state is checked (step S122). In the case of the in-plane state, information from the motion detection result is awaited and the coordinates of the target block are read (step S123). From the coordinates of the target block, the state of the next loop is calculated (step S124). Then, the transfer destination address is calculated (step S125). In this step, as the address, the coordinates of the beginning address in the image memory 40 are calculated. Furthermore, the transfer source address is calculated (step S126). In this step, as the address, the coordinates of the beginning address in the secondary memory 60 are calculated.

The respective calculated addresses are issued to the respective memories (step S127). The respective data reading and data writing are executed and the beginning addresses are incremented (step S128), so that the processing returns to the step S122.

If the state checked in the step S122 is the out-plane state, the transfer destination address is calculated (step S129). In this step, as the address, the coordinates of the beginning address in the image memory 40 are calculated. Furthermore, the transfer source address is calculated (step S130). In this step, as the address, the coordinates of the beginning address in the secondary memory 60 are calculated.

The respective calculated addresses are issued to the respective memories (step S131). The respective data reading and data writing are executed and the beginning addresses are incremented (step S132). Thereafter, whether or not the copy for one frame has been ended is determined (step S133). If the copy has not been ended, the processing returns to the step S122. If the copy for one frame has been ended, this processing is ended.

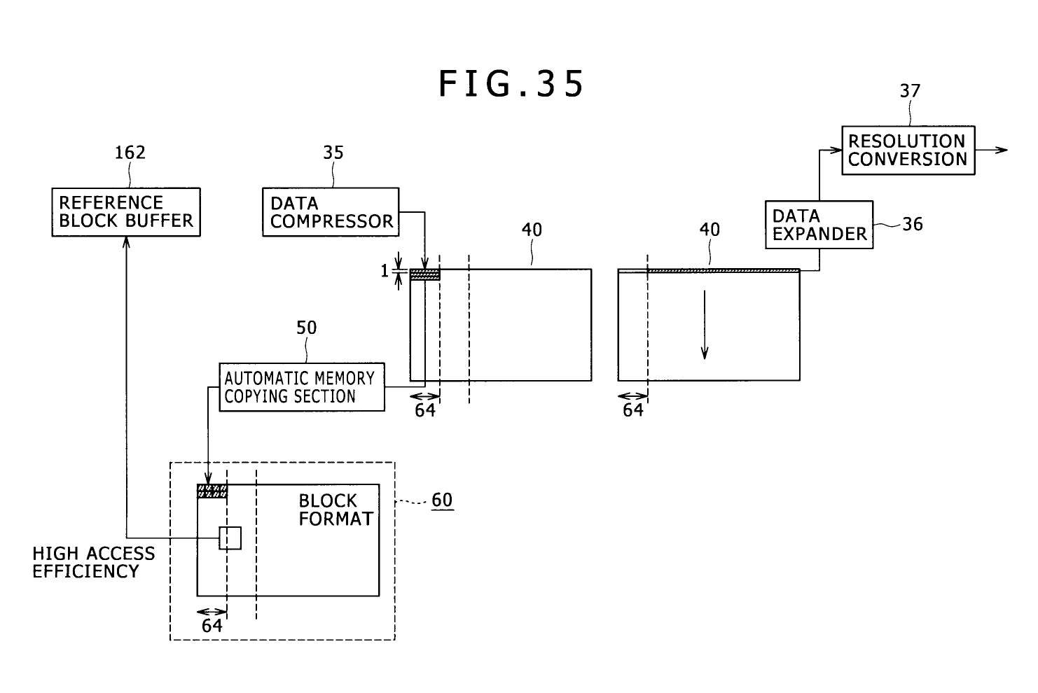

The state in which data are stored in the image memory 40 and the state in which data are read out from the image memory 40 will be described below with reference to FIG. 34 and FIG. 35.

To perform frame NR, data corresponding to one screen should be written onto the high-capacity memory. To reduce this data of one screen, the data are compressed in any form. If compression by use of DCT transform typified by the JPEG system is performed, the data as the compression subject are a power-of-two block such as a block of 8 pixels×8 pixels. Furthermore, such a compression technique compresses the whole data of one screen and therefore it may be impossible to expand only the necessary part later.

In the imaging device of the present embodiment, most of the circuits at the subsequent stages of the high-capacity memory 40 are circuits that execute processing on a line-by-line basis, such as the moving image codec 19 and the NTSC encoder 20. Therefore, it is convenient that expansion processing is executed little by little in units of the line also for the high-capacity memory.

Thus, the data compressor 35 compresses data in units of 64 pixels×1 pixel (one line), obtained by further dividing the target block unit (64 pixels×64 pixels) in units of one line. As this compression processing, e.g. image data of 64 pixels×1 line are compressed to the ½ data amount by broken line approximation and data reordering. If such compression is performed, data access and expansion are easy also when a read signal is subjected to output processing as an NTSC signal and codec processing as the subsequent-stage processing after data are subjected to frame NR and then written to the memory 40.

Therefore, in the present embodiment, compression may be performed in units of 64 pixels on one line because horizontal 64 pixels are equivalent to the input width of the vertical direction processing (strip processing) of frame NR as shown in FIG. 34. The signal of 64 pixels on one line is (8+8)×64=1024 bits in the case of a luminance signal of 8 bits and a color difference signal of 8 bits for example, and the data thereof are compressed.

The data written to the image memory 40 for one frame in this manner are read out as data in units of one horizontal line in the data expander 36 and supplied to the resolution converter 37 so as to be converted to image data that can be treated in the subsequent-stage image data processing system.

As shown in FIG. 35, when data stored in the image memory 40 are copied by the automatic memory copying section 50, the image data of the desired area are expanded and format-converted to be read out to the secondary memory 60 based on the coordinates of the target block. At this time, the image data in units of 64pixels×1 line written to the image memory 40 are read out for 64 lines. Accordingly, the data in units of the target block are read out. Then, the image data of the desired reference block are supplied from the secondary memory 60 to the reference block buffer 162 and processing of calculating the SAD value with the target block is executed.

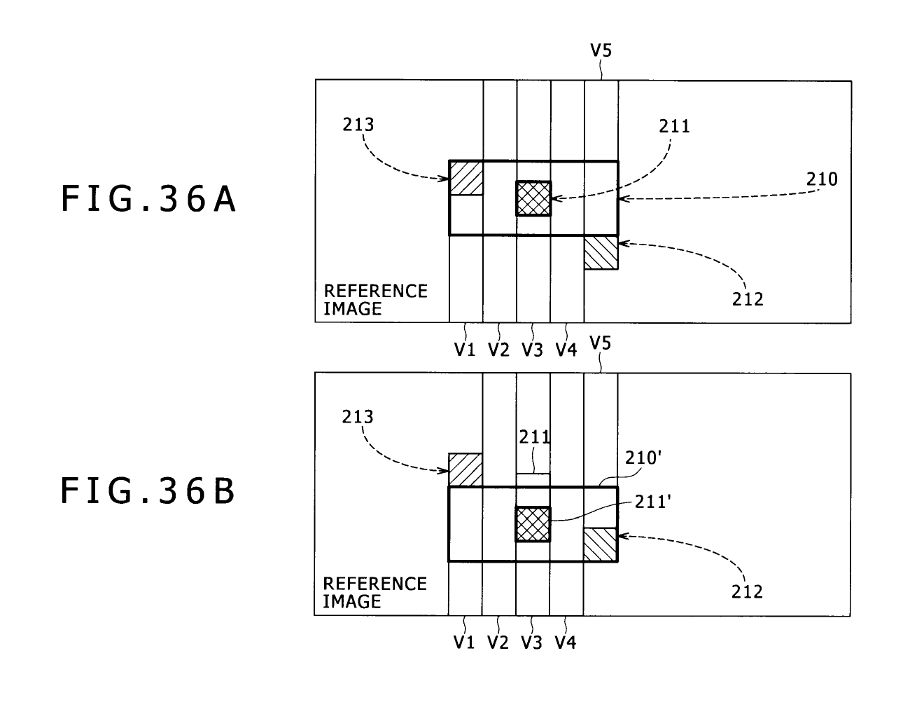

FIGS. 36A and 36B show examples of the range transferred from the image memory 40 to the secondary memory 60 and the range that is possibly further sent from this secondary memory 60 to the reference block buffer 162. That is, the range that is possibly accessed depending on the result of motion vector detection in the reduced plane should be retained although all of the range is not necessary.

In this example, the block obtained by projecting the coordinate position of the target block onto a reference image is a center block 211 and the above-described search range is defined by ensuring a search range around this block in such a manner that this block is the center. FIG. 36A shows the processing state at certain timing, and FIG. 36B shows the state when the position of the target block is forwarded by one block from the state of FIG. 36A.

In this case, there is a possibility that the data in a search range 210 around the center block 211 are read out to the reference block buffer 162 and data including the search range 210 should be stored in the secondary memory 60. In the image memory 40, data converted to blocks in the strip form are stored as already described. In the example of FIG. 36A, data of the respective blocks on strip-like vertical block lines V1, V2, V3, V4, and V5 are copied to the secondary memory 60. However, regarding the block line V5 as the latest line, data to a block 212 used at the next processing stage have been read out to the secondary memory 60. Regarding the block line V1 as the last line, data before a block 213 that is unnecessary in the next processing have been already erased from the secondary memory 60.

In this state, the data in the search range 210 around the center block 211 are transferred to the reference block buffer 162 as the primary memory and a search is performed.

Suppose that, as shown in FIG. 36B, the coordinate position of the target block processed by the motion detection and motion compensation section 16 is moved from the center block 211 to a block 211′ immediately under the block 211. At this time, the search range 210 also becomes a search range 210′ resulting from downward movement by each one block and the corresponding data are transferred from the secondary memory 60 to the reference block buffer 162. This search range 210′ includes the block 212 and the block 213 has already become an unnecessary block. Therefore, in this state of FIG. 36B, further the block under the block 212 is read out to the secondary memory 60 and the data of the block 213, which has already gotten out of the search range 210′, are erased from the secondary memory 60.

In this manner, the range of data read out to the secondary memory 60 progresses in one frame. When the range has progressed to the last block of one frame, processing of reading the data of the beginning part of the next frame to the secondary memory 60 in advance is executed.

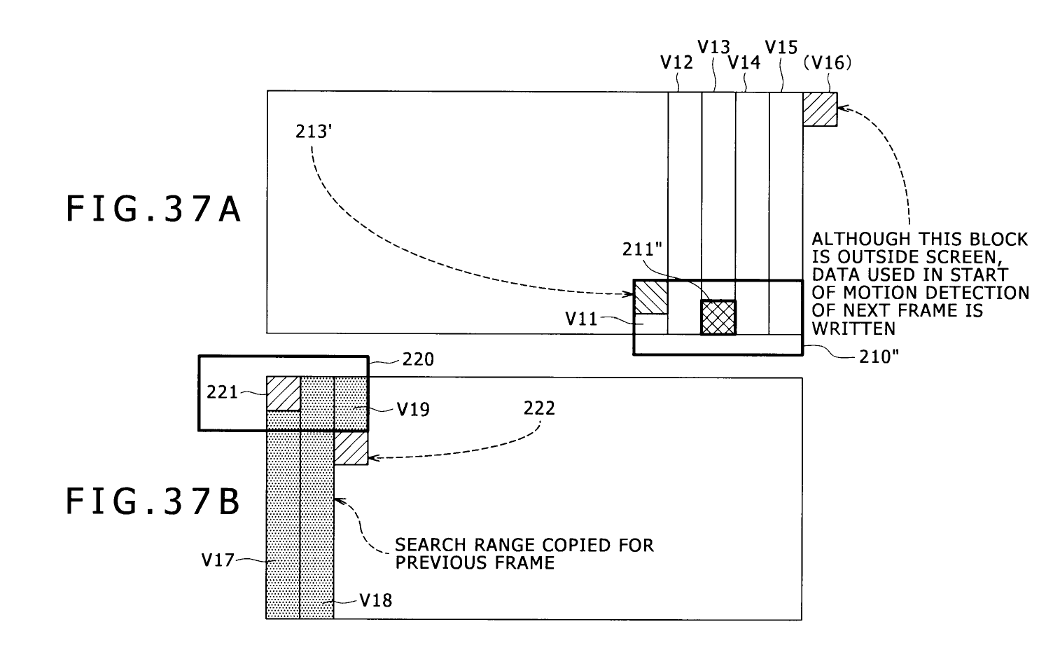

Specifically, suppose that, as shown in FIG. 37A, a center block 211″ gets close to the lower right end of one frame and a search range 210″ has moved to the lower right end of one frame. At this time, if it is assumed that data on strip-like vertical block lines V11, V12, V13, V14, and V15 have been transferred to the reference block buffer 162, the block to be read out next is on a line V16 outside the screen of one frame if this goes on. So, in the present example, in such a situation, reading of the blocks on block lines V17, V18, and V19 around the left end of the next frame is started and the data of these blocks are transferred to the secondary memory 60 as shown in FIG. 37B.

Therefore, as shown in FIG. 37B, the data in a search range 220 around a center block 221 as the target block are read out to the secondary memory 60 at the start timing of a search of the next frame. Thus, the data in the search range 220 can be immediately transferred from the secondary memory 60 to the reference block buffer 162 as the primary memory, and a search can be executed.

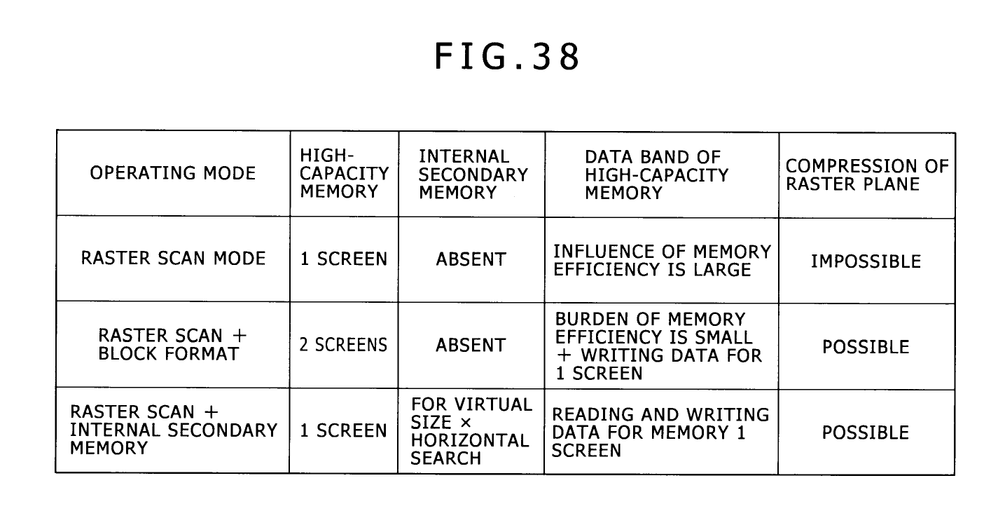

FIG. 38 shows comparison between the processing of the present embodiment and other kinds of processing proposed as the related art. Among the operating modes in FIG. 38, [raster scan+internal secondary memory] on the lower row is equivalent to the processing of the present embodiment. Furthermore, [raster scan mode] on the upper row corresponds to the case in which the secondary memory is not provided and data are stored in the image memory 40 in a raster scan mode. Moreover, [raster scan mode+block format] on the middle row corresponds to an example in which data are stored in the image memory 40 in a raster scan mode and stored also in a block format.

In the case of [raster scan mode] shown in FIG. 38, data transfer from the image memory 40 as a high-capacity memory to the reference block buffer 162 frequently occurs. Thus, the use efficiency of the data band of the image memory is low and the memory efficiency is low. Furthermore, compression of data stored in the memory may be impossible.

In the case of [raster scan mode+block format], the burden of the memory efficiency can be reduced because data of the block format can be read out. However, the high-capacity memory to store the data of one frame needs capacity for two screens and thus excess writing for one screen is necessary.

In contrast, [raster scan+internal secondary memory] of the example of the present embodiment has advantageous effects that it is enough for the image memory 40 as a high-capacity memory to have storage capacity for one screen and the efficiency of reading and writing is also high.

As described above, according to the example of the present embodiment, data are efficiently stored in the image memory 40 configured by a DRAM or the like in a format resulting from compression of image data having a comparatively-large data amount. In addition, the data stored in the image memory 40 are written to the primary memory in the motion detection and motion compensation section 16 via the secondary memory 60. Therefore, the data are efficiently written to the primary memory. That is, only the data of the area in which a search is performed are written in the primary memory, while the area that is redundantly read out possibly for convenience of frame scan is left in the secondary memory. Thus, the access to the image memory 40 may be the minimum. Furthermore, writing to the secondary memory is performed in the state in which the image data have already become data of a format suitable for block matching by processing in the automatic memory copying section 50 shown in FIG. 2. Thus, it is enough that the data of the desired area are merely copied from the secondary memory to the primary memory, and the copy can be performed with a light processing burden.

The movement of the copy block shown in FIGS. 36A and 36B and FIGS. 37A and 37B are one example and another processing configuration may be employed. The number of pixels configuring one block may also be one example and another configuration may be employed. Copy may be performed not in units of the block but in units of one line or one pixel.

Although the above-described embodiment is the case in which an image processing device according to one embodiment of the present disclosure is applied to an imaging device, the present disclosure is not limited to the imaging device but can be applied to various image processing devices.

The above-described embodiment is the case in which one embodiment of the present disclosure is applied to noise reduction processing through image superposition by use of a block matching technique. However, the present disclosure is not limited thereto but can be applied to all image processing devices in which plural processors access image data written to an image memory section.

The present application contains subject matter related to that disclosed in Japanese Priority Patent Application JP 2011-000803 filed in the Japan Patent Office on Jan. 5, 2011, the entire content of which is hereby incorporated by reference.

It should be understood by those skilled in the art that various modifications, combinations, sub-combinations and alterations may occur depending on design requirements and other factor in so far as they are within the scope of the appended claims or the equivalents thereof.

What is claimed is:

1. An image processing device comprising:
an image processor configured to calculate a motion vector between image data of a target frame and image data of a reference frame in units of a block;
a reference frame image memory configured to retain image data of a past frame as the image data of the reference frame;
a primary memory configured to retain a matching processing range of the reference frame in calculation by the image processor; and
a secondary memory configured to read out and retain image data of a desired range from the image data of the reference frame stored in the reference frame image memory, the secondary memory reading out data of the matching processing range from the retained image data and supplying the read data to the primary memory.

2. The image processing device according to claim 1, wherein
the reference frame image memory is a memory that retains image data converted to a predetermined format, and
format conversion from the predetermined format is performed in supply of the image data retained in the reference frame image memory to the secondary memory.

3. The image processing device according to claim 1, wherein
the reference frame image memory is a memory that retains image data subjected to compression processing in a predetermined format, and
the image data subjected to the compression processing are supplied after being subjected to expansion processing in supply of the image data retained in the reference frame image memory to the secondary memory.

4. The image processing device according to claim 1, wherein
the image processor sets a position at which the image data of the reference frame are added to the image data of the target frame based on detection of the motion vector, and executes addition processing of images of a plurality of frames at the set position.

5. The image processing device according to claim 4, wherein
one of noise removal and noise reduction of an image is performed in the addition processing of the images of the plurality of frames by the image processor.

6. An image processing method comprising:
calculating a motion vector between image data of a target frame and image data of a reference frame in units of a block;
retaining image data of a past frame as the image data of the reference frame;
retaining a matching processing range of the reference frame in such a state that reference to the matching processing range in the image processing is possible in calculation of the motion vector in the image processing; and
reading out and retaining image data of a desired range from the image data of the reference frame retained in the reference frame retention processing, and reading out part of the retained image data and sending the part of the retained image data to the matching processing range retention processing.

7. The image processing method according to claim 6, wherein
the reference frame retention processing is processing of retaining image data converted to a predetermined format, and
format conversion from the predetermined format is performed when the image data retained in the reference frame retention processing are read out and the intermediate retention processing is executed.

8. The image processing method according to claim 6, wherein
the reference frame retention processing is processing of retaining image data subjected to compression processing in a predetermined format, and
the image data subjected to the compression processing are supplied after being subjected to expansion processing when the image data retained in the reference frame retention processing are read out and the intermediate retention processing is executed.

9. The image processing method according to claim 6, wherein
the image processing is processing of setting a position at which the image data of the reference frame are added to the image data of the target frame based on detection of the motion vector, and adding images of a plurality of frames at the set position.

10. The image processing method according to claim 9, wherein
one of noise removal and noise reduction of an image is performed in the processing of adding the images of the plurality of frames in the image processing.
